(19) United States
(12) Patent Application Publication
(10) Pub. No.: US 2023/0306817 A1
(43) Pub. Date: Sep. 28, 2023

(54) MULTI-DISCOUNT PERCENTAGE AWARDS GAMING SYSTEM

(71) Applicant: Mark Anthony Strom, Avondale (NZ)

(72) Inventor: Mark Anthony Strom, Avondale (NZ)

(21) Appl. No.: 18/117,512

(22) Filed: Mar. 6, 2023

Related U.S. Application Data
(60) Provisional application No. 63/322,377, filed on Mar. 22, 2022.

(51) Int. Cl. G07F 17/32

(52) U.S. Cl. CPC G07F 17/3255

(57) ABSTRACT

A finite probability discount and cashback gaming system are provided. The gaming application includes discounting a point-of-sale and/or accumulative-sale on set limit parameter purchasing and wagering transactions. Tiered multiple discount percentage awards range from 0.2% to 100%. The method may include predetermined random selections from a plurality of discount percentage award options and total purchasing and/or wagering limits on a gaming communication device having a processor; the gaming communication device displaying game initiating inputs on virtual image or mechanical tilted scale. The processor determines and displays accumulative multiple discount percentage and/or cashback awards, counter-balancing the opposite side of the scale, resulting in display of the final payment and/or cashback.

### RELATED U.S APPLICATION DATA

This application claims priority from U.S. Provisional Patent Application Ser. No. 63/322,377, filed 22 Mar. 2023.

### BACKGROUND OF THE INVENTION

The present invention relates to the field of gaming, gaming-related harm prevention and minimalization, wagering and/or purchasing reward programs.

“Gambling” (also known as betting) is wagering something of “value” (“the stakes”) on an “event” with an uncertain outcome with the intent of winning something else of value. Gambling thus requires three elements to be present: “consideration” (an amount wagered; under English common law consideration is a promise of something of value given by a promisor in exchange for something of value given by a promisee), “risk” (chance; Risk involves uncertainty about the effects/implications of an activity with respect to something that humans value, often focusing on negative, undesirable consequences), and a “prize” (is an award to be given to a person or a group of people to recognize and reward their actions and achievements)” Wikipedia.

Gambling plays such a big role in social interactions across the world—from buying scratch cards and lottery tickets, placing a bet while watching a football match with friends, attending horse racing events or playing roulette in a casino. It is widely accepted, and remote gambling is increasingly gaining popularity and legal status globally. The industry doesn't want to create problem gamblers, but rather provide a fun and exciting experience to its customers.

Responsible gambling is currently one of the top priorities for gambling businesses. With community pressured regulators increasingly cracking down on various problem gambling activities, it's more important than ever for operators to improve their image and go the extra mile to help their customers enjoy their betting and gaming experience safely. However, it is equally important to continue developing and evolving products to remain in competition and provide a user experience that matches other leading digital products out there.

Responsible product design literature has several reassuring trends, such as widespread use of experimental methods and behavioral measures. But uncertainty about the literature's overall methodological rigor, replicability and transparency precludes any strong recommendations about which interventions stakeholders should promote and implement. Ignoring these important factors, currently the product safety literature provides the best evidence, albeit limited evidence for pop-ups with self-appraisal messaging, breaks in between rounds of play, pre commitment to less risky bets, undoing Electronic Gaming Machine (EGM) features that promote excessive gambling, providing recommendations that minimize house edge, and removing banknote acceptors because the literature remains premature. Until there are a much larger number of high-powered, transparently reported studies, confident evidence-based product safety recommendations remain elusive. The objective was systematic mapping of evaluations of tools and interventions that are intended to mitigate risks for gambling harm and the conclusion was greater transparency and precision are paramount to improving the evidence base for responsible product design to mitigate gambling-related harm.

Going above and beyond the standard Responsible Gambling requirement has resulted in attempts to embed tools to assist with preventing and minimizing gambling-related harm. These include technologies like ‘Reality checks’, ‘Cool Off periods’, ‘Self-Assessment Tools’ & ‘Screen-time monitoring’ etc. to name a few albeit interruptive experiences. There is an ongoing development to come up with and provide better tools, systems and methods to address the issue. An assessment between cost and benefit of these tools has not been fully researched to see that in addition the customer is in favor of, or is the stakeholder attempting to skirt requirements to present a responsible host condition to maintain license conditions and market presence? Considering player safety for some and satisfaction for all is a difficult balance to attain in this environment with a ferocious appetite for constant new content being the real challenge.

Most people gamble for fun and entertainment and a chance to win big without causing harm to themselves or others. But for a few there is a psychological problem according to countless ongoing global studies in legal jurisdictions. Most if not all think a gamble, wager or flutter is a low risk high return proposition when it is in fact the exact opposite.

Reel-type games (both Mechanical slots with wheels or reels that rotate about an axis or Video slots that display virtual reels with symbols thereon) are important components of the entertainment provided by land-based, on-line and wireless casinos and are equally important centers of profit for these casinos.

Various forms of reel-type games have been used commercially for over one hundred years. Today's traditional video slot machine paylines of symbols aligned horizontally on a machine have become the standard in the trade. Original paylines were usually provided with three or five symbols being displayed on the payline. The traditional five frame symbols developed because many early reel-type displays were based on stud or draw poker hands where five cards were provided. The use of artificial symbols on paylines (bells, cherries, sevens, plums, lemons, oranges, bars etc.) allowed designers more freedom in payline development and simplified machines by providing three frame displays on the payline.

In reel-type games the award for the primary or base game is based on the player obtaining a winning symbol or symbol combination on the payline(s) and on the amount of the wager placed on the primary or base game. Generally, symbols or symbol combinations which are less likely to occur usually pay higher awards, but most symbol combinations within the total cycle are unmatched and non-paying.

Classified ‘Class III’ EGM's are fundamentally ‘random number generated’ events with a theoretical ‘return to player’ (e.g., RTP of 92%) and ‘house edge or advantage’ (e.g., 8%), generally within a 95% confidence of reaching them under the ‘law of averages’. In the long term modern popular video EGM's with their reel symbol mapping and randomness generally take's millions (e.g., 10 m) of events (spins) to reach a game's certified theoretical percentages. In the short term (i.e., player time on device wherein the average is 30-40 minutes or 300-400 spins) of individual play the gaming establishment operator will hold more (frequently) or less (occasionally) than the certified theoretical percentages. The gaming establishment operators ‘daily floor average (e.g., $150 a day)’ is the sum of all EGM earnings positive (more wagered then returned), negative (more returned then wagered) and non-played (idle) divided by the total amount of EGM's on their floor.

Return to player (RTP) is a measure of how much an EGM pays back to its players for each unit wagered over time. It is most expressed as a percentage value and is almost always below 100%. The difference between 100% and the EGM's certified RTP is known as the house edge, and this is the mathematical advantage that allows the casinos to make a profit over the long term. EGM's with an RTP closer to 100% are often termed ‘loose’ while games with a low RTP are referred to as ‘tight’.

For example, if an EGM provides a certified RTP value of 92% then the house edge is equal to 8%. This means that on average and over millions of spins the machine wins 8% of every unit wagered. Of course, a game that accepted a $1 wager and paid back a 92 c ‘win’ on every spin would be hideously boring, not to mention impossible for a player to win against. Therefore, EGM's are designed with paytables that give players a chance to win in the short term while still banking profits for their operators over the longer term and across a wide player base. As a player, picking a high RTP value, will prolong their play sessions over the long term, so they can enjoy more spins for their budget and get better value for their money.

Some games have an RTP range with a significant difference between the maximum and minimum values. This can indicate one of a few possibilities such as a game that has different paytables that may be chosen and/or configured by the gaming establishment operator, a difference in pay out based on the bet wagered by the player, or differences in bonus rounds that pay more or less based on choices made by players. The RTP values for games can change over time due to software updates and changes made to games by their developers (in online environments) or changing a games paytable from among various RTP configurations supplied to the brick-and-mortar gaming establishment operator (e.g., RTP values 90%, 92% or 95%) providing them RTP control generally gauged by management tools employed to monitor floor traffic and/or denomination.

It is important to note that games that are linked to create the alluring and popular progressive jackpots (e.g., popular 4-tiered mini, minor, major and grand) that form a part of the total RTP of a game can be misleading when a games RTP is advertised for example with a payback of 95%. Progressive jackpot slots usually take a proportion of each bet wagered and add it to the jackpot that is part of the total RTP of a game. This sum is sometimes called the “meter,” and it is normally taken from multiple EGM's (electronic gaming machines) at the same time and when it is claimed it will seed or reset to a set value. This means that, unless the player wins the jackpot, they'll be playing the game with an RTP significantly lower than what is advertised. Progressive jackpots influence total RTP of an EGM's primary or base game.

Generally, there may be several different EGM's (local and offered in a single venue) or participating linked venues (wide area progressives) that contribute to larger life-changing jackpots, but all require that the jackpot symbol must land on the designated payline of all 5 frames and qualified by maximum bet rules and the longer the jackpot goes unclaimed, the bigger it gets.

The heart of a Class III EGM is its certified random number generator (RNG) that generates thousands of outcomes per second constantly providing the element of chance and foiling any prediction of game event outcomes. The ‘Payback’ is the theoretical percentage of what the customer should retain (e.g., 92%), the ‘Hold’ is the theoretical percentage of what the operator should retain (e.g., 8%), the ‘Confidence Interval’ is the probability that the payback and hold percentages will fall within the parameters set by the manufacturer and the ‘Volatility Index’ determines the frequency and size of the pay outs. Therefore, over a short session of a few hundred or a few thousand spins, everything can happen, which is exactly what makes slots exciting. Here are 2 examples of achieving RTP in the certification process:

| | | VI - | | | VI - |
|---|---|---|---|---|---|
| 95% Confidence | | 30.94 | 95% Confidence | | 13.13 |
| | Low | High | | Low | High |
| #Games | RTP % | RTP % | #Games | RTP % | RTP % |
| 1,000 | 5.84 | 189.84 | 1,000 | 50.48 | 133.52 |
| 10,000 | 61.06 | 122.94 | 10,000 | 78.87 | 105.13 |
| 100,000 | 82.22 | 101.78 | 100,000 | 87.85 | 96.15 |
| 1,000,000 | 88.91 | 95.09 | 1,000,000 | 90.69 | 93.31 |
| 10,000,000 | 91.02 | 92.98 | 10,000,000 | 91.58 | 92.42 |

Following is the original and popular (Red, White & Blue 777) 3-reel 64-stop 1 payline mechanical slot game. A variety of ‘Sevens’ themed (e.g., Blazing Sevens) video slots in 3, 4 & 5-reel configurations exist today. Seven (7) remains the most synonymous top award symbol in slot games.

Reel Stack

| Symbol | Reel 1 | Reel 2 | Reel 3 |
|---|---|---|---|
| Blank | 24 | 28 | 29 |
| Blue 7 | 8 | 2 | 2 |
| White Bar | 12 | 4 | 9 |
| Red Bar | 4 | 12 | 12 |
| Blue Bar | 12 | 12 | 4 |
| White 7 | 2 | 2 | 6 |
| Red 7 | 2 | 4 | 2 |
| Total | 64 | 64 | 64 |

### Paytable

| Symbol | Hits | Hit % | Hit Rate | Pays | Total Pays | Pay % |
|---|---|---|---|---|---|---|
| RWB 7 | 8 | 0.00003 | 32768.00 | 400 | 3200 | 0.012207 |
| Red 7 | 16 | 0.00006 | 16384.00 | 250 | 4000 | 0.015259 |
| White 7 | 24 | 0.00009 | 10922.67 | 200 | 4800 | 0.018311 |
| Blue 7 | 32 | 0.00012 | 8192.00 | 150 | 4800 | 0.018311 |
| Any 7 | 880 | 0.00336 | 297.89 | 80 | 70400 | 0.268555 |
| RWB Bar | 64 | 0.00024 | 4096.00 | 50 | 3200 | 0.012207 |
| Blue Bar | 576 | 0.00220 | 455.11 | 40 | 23040 | 0.087891 |
| White Bar | 432 | 0.00165 | 606.81 | 25 | 10800 | 0.041199 |
| Any RWB | 144 | 0.00055 | 1820.44 | 20 | 2880 | 0.010986 |
| Red Bar | 576 | 0.00220 | 455.11 | 10 | 5760 | 0.021973 |
| Any RWB | 17952 | 0.06848 | 14.60 | 5 | 89760 | 0.342407 |
| Bar | | | | | | |
| Any Red | 752 | 0.00287 | 348.60 | 2 | 1504 | 0.005737 |
| Any White | 804 | 0.00307 | 326.05 | 2 | 1608 | 0.006134 |
| Any Blue | 1072 | 0.00409 | 244.54 | 2 | 2144 | 0.008179 |
| Blank | 19488 | 0.07434 | 13.45 | 1 | 19488 | 0.074341 |
| Paying | 42820 | 0.16335 | 6.12 | | 247384 | 0.9437 |
| Non-Paying | 219324 | 0.83665 | 1.19 | 0 | 0 | 0 |
| Cycle | 262144 | 1.00000 | 1.00 | | | |

Hit frequencies or win/lose ratio gambling events create necessary losing streaks which may be especially long in high volatile games. The question is “how long should one endure a losing streak?” as they cause the drain on the wager/stake in a game quickly. Losing streaks exist simply because of the hit frequency of a game and the payback on any winning combination. An easy formula for what is considered a ‘safe losing streak is payback×6’ and a ‘max losing streak is payback×8’.

Dissecting the above games paytable into 2 parts paints a very different picture. It has an overall hit frequency of 1 in 6.12 (16,335%) which in a true odds consideration an even bet would return 6.12 credits every time a win occurs, no fun or profit in that. Separating all the wins that pay less than the hit frequency and those that pay more follows:

| | Total | Pays Less | Pays More |
|---|---|---|---|
| Hits | 42820 | 40068 | 2752 |
| Hit Rate | 1 in 6.12 | 1 in 6.54 | 1 in 95.26 |
| Hit % | 0.16533 | 0.15290 | 0.01049 |
| Pay % | 0.9437 | 0.4368 | 0.5069 |

This reveals that 93.57% of all wins pay less than even money and the higher than even money odds occur on average 1 in 95.26 spins (1.05%) indicating a slow but gradual drain of the bankroll or stake.

Modern slots with multi-payline structures are far more complex than this simple format of a 3-reel 1-payline device but would still amount to similar or even worse distributions as demonstrated. Slots are the biggest contributor to problem gambling statistics in all legal jurisdictions according to studies. RTP % seems to be the only information players use to measure a perceived good vs bad game or more accurately value for money, but it is tied to hit frequency a mathematical contribution that may cause gambling-related harm.

Customer loyalty reward programs, bonusing, give-aways etc. are well-known marketing tools earning points and tier status based upon total spend to reward customers for their continued support as an integral part of operational marketing budgets. Customers could belong to a multiple of loyalty reward programs and it is generally advisable to join if you are a frequent visitor just as frequent flyer points are for air travel discounts and free flight benefits from an airline or retailers discount shopping vouchers and specials etc. Customers demand loyalty rewards wherein acquisition and retention strategies are important for revenue growth. Reward points may be earned by buying several services and products in and on their property, but gaming remains their core product and attraction, therefore rewards and bonuses are a calculated complimentary (a.k.a. comps) adding to the return to player percentages.

Problem Gambling is well-known in the gambling industry and is constantly monitored and researched in legal jurisdictions where ‘prevention and harm minimization’ regulations are imposed on licenses for operators and manufacturers of gambling equipment. Reel-type games due to their overwhelming popularity also figure highest in all problem gambling research as the main contributor to what has been classified a mental ill-being or sickness.

“Chance” is the word often used to describe something that happens unpredictably and without an observable cause, while on the other hand, “Luck” is the word often used when we prosper or succeed through chance. Gambling involves chance. When people win in gambling, we often say they are lucky. This is true even though they bought a chance to win by risking their money. Paying money to have a chance to win and then not winning can be frustrating but losing is what's going to happen most of the time.

Some people believe that luck can be influenced or earned—that someone with “good fate” or who is “due” for a favor from a higher power will win more than lose. Thoughts like this can make someone vulnerable to gambling more than they can afford. The truth is that, while anyone can get “lucky” in the short term, over the long-term gamblers are almost certain to purchase and/or wager more than they win.

Short Term Volatility versus Long Term Predictability: Randomness, independence of events and house advantage conclude that all these factors help ensure that the gaming establishment operator will make money over time, on the other hand, it is always possible to win on any single bet. Gaming establishment operators know that, in the short term, a player can win (short term volatility), but if someone continues to gamble, it becomes more and more likely that the overall results (cumulative) will be a loss (long term predictability).

The “Law of Averages” closely related to long term predictability is a mathematical concept. In gambling, it basically means that, over the long term, your actual overall results (cumulative) will tend to drift toward the long-term average results for that game. For example, if you flip a coin continuously for days on end, the overall results will tend to drift towards 50% heads and 50% tails, even though every flip is random and independent of all other flips.

Charitable gaining is generally conducted by selling popular paper pull-tabs or instant prize scratch tickets. Electronic Pull-Tabs (e-tabs) are growing in popularity and will soon overtake the paper product in markets where they are legalized for the purpose of raising necessary funding for charities and state governments. They are finite and predetermined wherein each game has a definite pay-out and profit. They are fixed by the number of tickets in a deal, usually with low return to player (e.g., 80%) and moderate top awards (e.g., $500). They generally have for example a 5% win and a 95% loss ratio. The e-tab must stand-alone and are not permitted to mimic the play of slot machines.

Due to low cost of play and limited tickets in the deal they attract players mostly when associated with drinking at bars. One advantage of electronic pull-tab systems is that they provide more secure accountability than their paper counterparts and can be played more conveniently.

Of course, true odds eliminate the gamble and risk and legal gambling would be unprofitable, but there is an obvious mathematical cause and effect and is not just psychological as problem gambling studies heavily suggest.

Latest neuro-science also reveals that higher levels of dopamine (I want hormone) are released in the brain in the ‘anticipation of winning’ rather than in the winning itself, suggesting that once you get what you want (the anticipation) that is the reward rather than the prize. Does this also explain how absorbing losses is tolerated and encourages the want of that next dose of dopamine induced anticipation factor?

Science, habit and/or circumstance aside, the mathematical contribution between “winning vs losing” and its effect on the decline of a player's wager/stake in a game or session of play especially on vigorous and continuous gaming activity plays a big role. Current wagering methods of reel-type games generally hold more of a single wager in the short term but will return the certified theoretical ‘return to player’ in the long-term, resulting in the player losing frequently and winning occasionally. Player numbers are a vital component for the survival of a game in this competitive environment especially in the crowded on-line/wireless iGaming sector where ‘user acquisitions’ may be around 30-50% of the gaming establishments operational costs due to ‘Affiliate Programs’ and advertising etc.

At-risk gambling behavior, although psychological, may be even more mathematical? For a classified at-risk player that requires no skill or knowledge to play a reel-type game is generally unaware of the effects of hit frequency and volatility, return to player percentages and the law of averages has on their wager or stake. It is clear how a player and especially a vulnerable player may fall into harmful and severe at-risk gambling behavior mathematically. A player who has the means to lose large amounts of money over time can be classed as a severe problem gambler but unless they seek help it will go undetected, thus the numbers provided in studies only reflect players who seek help for their problem.

The ‘Return to Player (RTP)’ percentage attracts play more than content themes, graphics, animations, brands etc., and the gaming establishment operators market their slot RTP's to attract players and compete with all other gaming establishment operators.

Without delving into the psychological effects of all the ingredients of what makes up a reel-type game (e.g., odds, graphics, animations, colors, sounds, themes, brands etc.) the mathematical design of the game is truly a contradictory goal of attracting players to risk their discretionary wager/stake and earning continuous revenue for the licensed gaming establishment operator who in some cases are charitable non-profit organizations. Unfortunately for a small group of players (2%) studies reveal that all gambling activity can result in harmful and severe problem gambling behavior and a clear majority of reported cases are associated with reel-type games.

Some jurisdictions have banned all reel-type gaming products while others regulate and recognize the gambling industries contribution to their economy. Innovation is the hallmark of this growing industry that needs to satisfy the ferocious appetite of players seeking fun and entertainment.

Accordingly, it seems that any time there's a change in compliance, everyone goes through lots of hoops to get it ticked off, but very few operators and manufacturers produce something above the required solution to help end users, only sparking the development of embedded responsible gambling tools interrupting the customers gaming experience.

In the U.S.A all gambling winnings are considered taxable income, but fortunately, although you must list all your winnings on your tax return, you don't have to pay tax on the full amount. You can list your annual gambling losses as an itemized deduction on your tax return. If you lost as much as, or more than, you won during the year, you won't have to pay any tax on your winnings. Even if you lost more than you won, you may only deduct as much as you won during the year.

U.S. Pat. No. 8,876,589 describes a gaming machine requiring multiples of 2-coin wagering increments. Comprising a display of 2 video poker hands with 2 decks and wherein the play of a first-hand (1^{st} coin wager) consisting of 52 suit only cards (4×13) Hearts, Diamonds, Spades and Clubs, may result in the hold and draw of a non-flush, 4-card flush (e.g., pays 1) or 5-card flush (e.g., pays 5) ending the play of the first hand and wager. The second hand (2^{nd} coin wager) consisting of 52 rank only cards (13×4) Ace, King, Queen, Jack, 10, 9, 8, 7, 6, 5, 4, 3 and 2. The standard video poker paytable for winning hold and draw rank hand awards (e.g., a pair of Jacks, pays 1) applies to the second hand but if the first hand resulted in either a 4 or 5 card flush it will trigger a bonus pay on the winning rank hand award (e.g., 4-card flush & a pair of Jacks pays 2 or 5-card flush & a pair of Jacks pays 5). Therefore, the player may win on either the first or second-coin wager, or both. The method of play described here forces a multi-wager to increase hit frequencies, awards and bonuses on standard video poker and/or slot games.

Discounts are a reduction made from the gross amount or value of something; such as a reduction made from a regular or price list offering customers a 10% discount, buy tickets at a discount, a proportionate deduction from a debt account usually made for cash or prompt payment, a deduction made for interest in advancing money on or purchasing a bill or note not due. In today's world, savvy shoppers are always on the lookout for the best discounts and is a great way to attract new customers as well as keep those loyal happy at all times. Types of discounts include loyalty rewards, coupons (according to Statista 60% of online buyers searched for coupons), two for the price of one known as buy one get one free, and free delivery/shipping, complimentary products or services and giveaways.

Loyalty Reward programs wherein points are earned according to spend amount and frequency have pros and cons. For example, a high tier status (e.g., platinum) earns better discounts and rewards but can be loss due to inactivity (e.g., downgraded to silver) weakening the value of discount and reward redemption formerly entitled. Coupons or Vouchers entitle the holder to discounts on goods and services generally accompanied with redemption timeframes and expiry dates. “Buy one get one free” sounds like a penalty to the former buyer and a reward for the latter buyer? Or is it a stock clearing exercise? Free delivery/shipping products must equal the cost of an in-store or pick-up purchase and complimentary rewards and giveaways are exactly that.

Regardless of the method of rewards the costs of discount marketing to the provider business generally ranges from 1-5% of gross revenue depending on their growth objectives, wherein customer acquisition and retention is the goal.

### SUMMARY OF THE INVENTION

A method of providing a variable, fixed, finite probability, discount percentage award game includes:
a. providing a game processor and a display screen in communications with the game processor;
b. the game processor recognizing a wager of value in an underlying game of chance executed by the game processor;
c. before during or after executing the underlying game of chance, the game processor identifies a specific value or percentage to be used in the computation of discount percentage awards and cashback awards;
d. the game processor displaying the value or percentage to be used in the computation of discount percentage awards and cashback awards;
e. the game processor or live game table executing the underlying game to a result conclusion;
f. Information regarding the result conclusion of the underlying game is accessed by the game processor; and
g. based on the result conclusion and identified specific value or percentage identified for use in computation of discount percentage awards and cashback awards, the game processor displays respective discount percentage awards and cashback awards on the display screen and credits corresponding credits to respective accounts for discount percentage awards and cashback awards.

### BRIEF DESCRIPTION OF THE FIGURES

FIG. 1. Shows a 4-tier virtual symbolic distribution bar of 1×A, 2×B, 3×C & 4×D providing 10 hierarchical virtual fixed reel symbolic probabilities

FIG. 1A. Shows a 4-tier virtual symbolic distribution bar of 1×A, 1×B, 1×C & 1×D providing 4 non-hierarchical virtual fixed reel symbolic probabilities.

FIG. 2. Shows a 7-tier virtual symbolic distribution bar of 1×A, 2×B, 3×C, 4×D, 5×E, 6×F & 7×G providing 28 hierarchical virtual fixed reel symbolic probabilities.

FIG. 2A. Shows a 7-tier virtual symbolic distribution bar of 1×A, 1×B, 1×C, 1×D, 1×E, 1×F & 1×G providing 7 non-hierarchical virtual fixed reel symbolic probabilities.

FIG. 2C is a perspective view of A gaming machine with the top box rotating;

FIG. 2D is a perspective view of the gaming machine of FIG. 2C with the top box rotated into a different position;

FIG. 3. Shows a 10-tier virtual symbolic distribution bar of 1×A, 2×B, 3×C, 4×D, 5×E, 6×F, 7×G, 8×H, 9×I & 10×H providing 55 hierarchical virtual fixed reel symbolic probabilities.

FIG. 3A. Shows a 10-tier virtual symbolic distribution bar of 1×A, 1×B, 1×C, 1×D, 1×E, 1×F, 1×G, 1×H, 1×I & 1×J providing 10 non-hierarchical virtual fixed reel symbolic probabilities.

FIG. 4. Shows a 4-tiered shoes 100% complete discount percentage award distribution with highlighted random selected scale.

FIG. 5 is a comparison of 6 figures, FIGS. 5A, 5B, 5C, 5D, 5E and 5F, each showing incremental tier levelled discount percentage award scaling devices or displays.

FIG. 6. Shows a schematic of a user/provider interactive process.

FIG. 7. Shows a gaming server with options connected to an end user via wireless network carrier.

FIG. 8 shows a mobile device with 801 exchange credit paytable, 802 an exchange credit meter displaying discount or cashback credits for redemption only, 803 is the ‘2+1’ player-initiated incentive that guarantees a minimum return on 3 consecutive trade and exchange events guaranteed minimum return of e.g., 70% by delivering two negative wins plus one positive win to the exchange credit meter and, 804 a fixed trade credit amount (e.g., 100) that functions as a player-initiated start button, 805 is the trade credit meter displaying tradable credits only, 806 showing the ⅓^{rd} hit frequency bracket of positive wins on the exchange paytable and 807 showing the ⅔^{rd} hit frequency bracket of negative wins on the exchange paytable, 808 is a multi-trade and exchange selector in 2-trade increments (e.g., 2, 4, 6, 8, 10) of consecutive trade and exchange events, 809 is the denomination selector. 810 is a player-initiated option where a predetermined random hit frequency streak ratio between positive and negative wins is selected for 10 consecutive trade and exchange events. All shaded buttons are player interactive.

FIG. 9 shows the number of randomly distributed redeemable predetermined exchange credits within FIFO queues per ‘Set’ (All) for ‘single and double play’ trade and exchange events and the separated negative win versus positive win exchange awards that reflect the 2-1 negative-positive win ratio delivery method for the ‘triple play’ option and another negative win versus positive win exchange awards the ‘streaks’ ratios delivery method to cater to the 4 trade options.

FIG. 10 shows the central controller for pooling non-redeemable trade credits for the distribution of redeemable exchange credits from and to a community of linked electronic devices.

FIG. 11 shows an alternative function that can be provided on a gaming machine, smart phone, pad, computer screen or the like as a trade and exchange command function as described herein.

FIG. 12 shows a screen layout with cost of trade and service fee, exchange rates, positive win/negative win ratios, player available credits, selected trade credits, hit frequency options and highest award and win credits.

### DETAILED DESCRIPTION OF THE INVENTION

A method of providing a variable, fixed, finite probability, discount percentage award game includes:
a. providing a game processor and a display screen in communications with the game processor;
b. the game processor recognizing a wager of value in an underlying game of chance executed by the game processor;
c. before during or after executing the underlying game of chance, the game processor identifies a specific value or percentage to be used in the computation of discount percentage awards and cashback awards;
d. the game processor displaying the value or percentage to be used in the computation of discount percentage awards and cashback awards;
e. the game processor or live game table executing the underlying game to a result conclusion;
f. Information regarding the result conclusion of the underlying game is accessed by the game processor; and
g. based on the result conclusion and identified specific value or percentage identified for use in computation of discount percentage awards and cashback awards, the game processor displays respective discount percentage awards and cashback awards on the display screen and the game processor credits corresponding credits to respective accounts for discount percentage awards and cashback awards.

The method may have the underlying game executed on a slot machine and especially on a network of slot machines connected electronically (wired or wireless) through a game controller or game processor, with a random number generator on the slot machine and/or on the game processor identifying random outcomes in the execution of the underlying game, and herein the underlying game is executed on a live gaming table, and the video display is used to identify specific payments at as a result conclusion providing and underlying game concluding that requires an award to at least one player.

Another novel aspect of this system is a functional player input mechanism within the player controls, with player entry capability for gaming apparatus input (e.g., by way of non-limiting examples, through a button, recognized voice entry, or icon) which initiates a signal to the gaming process to enable a player to elect at least one event selected from the group consisting of a trade of credits between different players and an exchange of credits for an award (cash, vouchers, prizes, show tickets, lottery tickets, meals, etc., the exchange being with the event manager, game manager, casino, site of the apparatus, etc.) available for a defined number of credits over a spin and alternate between the two wherein the autonomous trading credits are deducted from their credit meter into a pool from where exchange credits are credited back to their credit meter in a player community competition for credits from any slot machine

The display screen displays a virtual image of a balance system, with two supplementary percentages that add up to 100%, with one display limited to a range of 2.02% to 100% display of a percentage. The method may be executed the one display of percentages is randomly selected by the game processor, and the virtual image is displayed before start of a game event, during play of the game event and/or upon conclusion of the game event. The display screen may be on or in a top box. The top box may be electronic, virtual display system, electrically driven mechanical element, mechanical device carrying a virtual screen(s), and combinations of these different formats for displays on top boxes.

In one embodiment, the top box contains a physically moving element with two distinct opposed viewing areas, one viewing area for display of the discount percentage award and another viewing area for display of the cashback awards. The two distinct opposed viewing areas comprise two individual viewing screens separated from each other. The two individual viewing screens may be supported on a bar which tilts to show differences between the discount percentage award and the cashback award. The method may be executed wherein outcomes in an underlying game are determined by a first random number generator and amounts of the discount percentage award and the cashback award.

A player at the game processor or live table game may connect a personal data apparatus to a server in communication with the game processor, and when a predetermined value of outcome results has been achieved, the server in communication with the game processor alerts the personal data apparatus of achievement of that redetermined value of outcome.

A gaming apparatus comprising a housing, player input controls, gaming processor, display screen for exhibiting information on an underlying wagering game and an area of view on the housing dedicated to display of amounts of a discount percentage award and a cashback award can execute the methods of the present invention.

wherein the game processor is programmed to select or enable selection of a range of discount percentage awards and to display that selected discount percentage award and the cash back award simultaneously. The gaming apparatus with a top box may contain a physically moving element with two distinct opposed viewing areas, one viewing area for display of the discount percentage award and another viewing area for display of the cashback awards. The gaming apparatus may have the two distinct opposed viewing areas comprise two individual viewing screens separated from each other. The gaming apparatus may have the two individual viewing screens supported on a bar which tilts to show differences between the discount percentage award and the cashback award. The gaming apparatus may have outcomes in an underlying game are determined by a first random number generator and amounts of the discount percentage award and the cashback award.

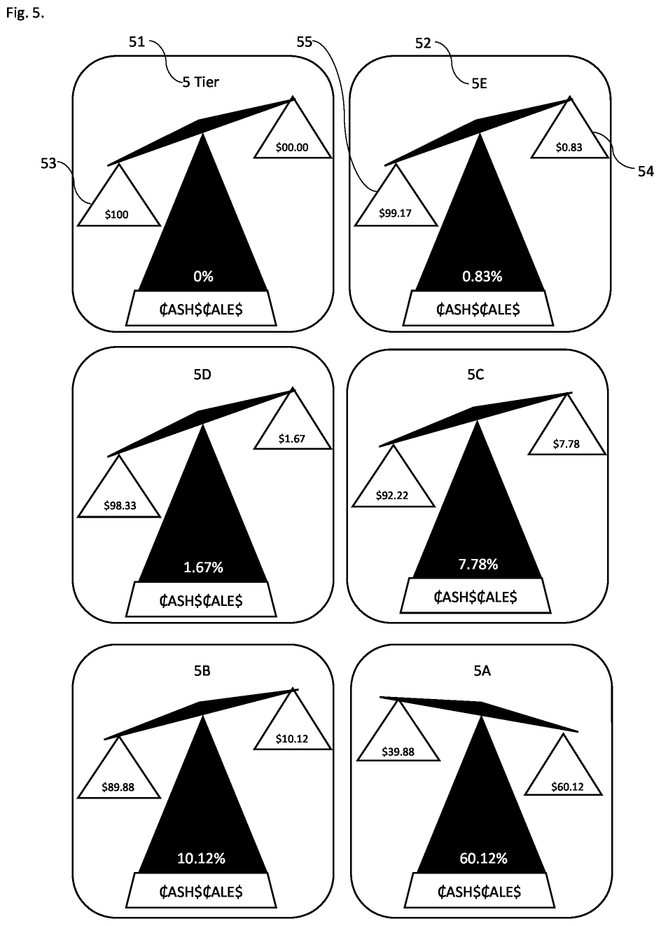

There are numerous options that can be embedded in the technology of the present invention with respect to the displayed value or percentage to be used in the computation of discount percentage awards and cashback awards. A simplest from a technology standpoint is at least two virtual, opposed, balanced display areas on a screen display. For example, as shown in FIGS. 5A, 5B and 5C, there is a fulcrum-based connection “supporting” two screens. The two values displayed are reciprocal (to 100%) for the discount credit award (rate) and the cashback award (rate). In FIGS. 5A-F, the discount credit award is both shaded (on the right) and white-on-black in the center. The center also may present an amount or as here, a percentage, being wagered on each particular round of a wagering event. Rather than a typical balance display, the images may be two opposed balloon-like elements distributed on opposite sides of a barrier. The balloons (round, oval, geometric, square, rectangular, etc.) may also inflate or deflate in size as well as having the numerical display shown on each balloon. Animated, anime′ or other characters may be used to contain the numerical display. For example, to promote conservative wagering, with smaller wagers, characters that appear more intelligent or well-to-do may be progressively shown as smaller wagers and/or higher discount credit rates are used (either automatically or by player selection or player-input preference.

Alternatively, a top box display could be used on kiosks or housings according to the present invention. The top boxes, in communication with the game processor, would have a mechanical balance, with the at least two displays on opposed sides of a fulcrum. The balance would literally tilt with the changes displayed values, and color displays could also be present on the “balanced” displays. Wires would pass through the arms of the fulcrum, and a geared drive or step drive or other incremental drive would shift the angle of the balance according to signals proportionating the angle of balance between the two awards. This top box system has a unique advantage in being able to be more easily retrofit into existing equipment, without major display redesign. The software in the random or selected reciprocal awards would be added into the game processor in the slot machine, the top box added, and the slot machine activated. The top box might be tilted towards the viewer/player. The top box may also have a purely virtual “balancing” display, rather than a mechanical display. This could also be easily retrofit. A generic video slot machine of the Prior Art as shown in U.S. patent application Ser. No. 15/584,529, filed 2 May 2017 (Pececnik) which is incorporated herein by reference in its entirety.

The multi-discount percentage awards gaming system of the present disclosure delivers predetermined finite randomly disbursed awards qualified by total purchasing and/or wagering set limit parameters.

Tiered discount percentage award pyramids are determined by the “Fixed Reel Award Distribution Algorithm” (FRADA) creating for example, triple, double and single virtual fixed reel symbolic hierarchical combinations. Accumulated discount percentage awards provide at least a guaranteed minimum discount (e.g., 2%) and chance of a maximum discount (100%) on the total purchase and/or wagering set limit parameters per scaled event.

Each tier structure has different and varying discount percentage award values wherein the bottom tier level has the lowest ‘Triple, Double, Single’ (TDS) virtual fixed reel symbol combination values and increase ascending through each tier level arriving at the top tier level with the highest TDS values and top discount percentage award (e.g., 100%). The shoe or deal is finite wherein all discount percentage awards are randomly disbursed until the shoe has been completely distributed. Upon completion of a single discount scale event the accumulated tier levels discount percentage awards are credited for instant and/or saved cashback redemption only.

Here is the summary table of the present disclosure:

| #Tiers | #Scales | Max. D % | Min. D % | RTP D % |
|---|---|---|---|---|
| 3 | 18 | 50 | 7.5 | 15 |
| 4 | 40 | 80 | 5.33 | 12 |
| 5 | 75 | 100 | 4.17 | 10 |
| 6 | 126 | 100 | 3.43 | 8.57 |
| 7 | 196 | 100 | 2.92 | 7.5 |
| 8 | 288 | 100 | 2.54 | 6.67 |
| 9 | 405 | 100 | 2.25 | 6 |
| 10 | 550 | 100 | 2.02 | 5.45 |
| All | 1698 | 100 | 2.02 | 6.71 |

In a preferred embodiment all tier (3-10) scale options are provided in the total make-up of the “Shoe/Deal”. All tiered structures are in a pyramid format, for example, in the 10-tier structure the 10^{th} and bottom tier level provides the sum of 10 discount percentage awards, 9^{h} tier level sum of 9 discount percentage awards, 8^{th} tier level sum of 8 discount percentage awards, 7^{th} tier level sum of 7 discount percentage awards, 6^{th} tier level the sum of 6 discount percentage awards, 5^{th} tier level the sum of 5 discount percentage awards, 4^{th} tier level the sum of 4 discount percentage awards, 3rd tier level the sum of 3 discount percentage awards, 2nd tier level the sum of 2 discount percentage awards and the top tier level 1 discount percentage award wherein the top discount percentage award exists. A total sum of 55 incremental discount percentage awards per 10-tier pyramid scale provides 550 scale events from within a finite probability of 30250 (55×10×55 FRADA) virtual 3-reel/1-line symbolic hierarchical combinations-based (triple, double, single read from left to right) cumulative discount percentage awards for each tier level. The top discount percentage award is the source of all discount percentage award derivatives within every tier option based on their hit frequency comparisons. All tier option configurations of the present disclosure follow this same structural discount percentage awards pyramid distribution method.

In an alternative embodiment the accumulative discount percentage awards managed distribution gaming method of the present disclosure may be applied to any point-of-sale or accumulated-sale environment including for example, all products and services provided within the gaming establishment operation (e.g., gaming, accommodation, restaurants, bar etc.), wholesale and retail outlets of all kinds etc.

In an alternative embodiment 4, 5 & 6-reel FRADA combination configurations may generate hierarchical and non-hierarchical virtual symbolic finite probability cycles and may include multiple lines to determine discount percentage awards and tier structures.

In an alternative embodiment the tiered discount percentage awards managed distribution method of the present disclosure may be played in single tier (e.g., 7-tier) option shoe only.

In an alternative embodiment the display of the discount percentage awards may include flipping of cards or tiles or any conceivable and recognizable method to reveal the incremental outcomes.

In an alternative embodiment the discount percentage award gaming system of the present disclosure may be played in any consumer purchase, wagering and service activity environment (e.g., horse racing, lotteries, retail, ticketing, online purchases and gaming, trade services etc.) within a brick and mortar or wire and wireless financial transaction terminal.

The set purchase or wager limit parameters automatically trigger the discount percentage awards gaming system of the present disclosure determining final discounted payment or cashback amount.

There exists a need to create new gaming and reward systems designed to deliver instant tangible cashback discounts at the point-of-sale to reduce the cost of play or purchase while providing a chance to win big discounts (e.g., 50%) and free play or purchase rewards (100%). Cashback only methods may assist in mitigating at-risk gambling behavior. Additionally, meet the regulatory “Class I” gaming definition to provide complimentary products that may promote new growth opportunities for the Native American casino industry and community. Develop new reward program that changes customer behavior to encourage increased purchasing and/or wagering with mutual benefits negating the demand for loyalty.

The method of the present disclosure is most conveniently described with reference to multi-tiered structures of finite fixed reel probability cycles wherein hierarchical scaled discount percentage award pyramids are distributed on electronic gaming communication devices interacting with and conducted at a point-of-sale terminal.

The player or customer will trigger an accumulative multi-discount percentage award scale by achieving a set purchase or wager limit (e.g., $100) or set parameter limit (e.g., $90-$100). The scale will start from the bottom tier level accumulating discount percentage awards while ascending through the tier levels reaching the top and last tier discount percentage award to finalize the total discount establishing their pay amount or cashback on a pre-paid amount. The top tier level (A) provides the top discount percentage award in all tier options equating its hit frequency to the number of scales e.g., 10-tier option has 550 scales thus a 1 in 550 chance of hitting (100%) and a 3-tier option has 18 scales thus a 1 in 18 chance of hitting (30%). All discount percentage awards within a tier option are derivatives of its top discount percentage award determined by dividing their descending tier level finite probability triple, double and single virtual combination hit frequencies accordingly (e.g., 1×100% discount award, A-A-A virtual triple symbol combination, being the mother providing hit frequency to discount percentage ratio's, 4×25%, 10×10%, 100×1%, 500×0.2%, 5000×0.02%). There can be multiple 100% discount award winners and big accumulative discount percentage award (e.g., 50%, 75% & 90%) winners within the shoes (1698 scales), but the return to player on the completed individual or all tier shoe is definite (e.g., 6%). Scales are randomly assigned, executed and eliminated from the shoe until completely emptied and replaced with new shoe.

Qualifiers win a discount percentage award (from 2%-100%).

Behind each tier level is the total finite probability set of virtual fixed reel symbolic hierarchical combinations determining discount percentage awards for every outcome in the “Fixed Reel Award Distribution Algorithm (FRADA)”. FRADA outcomes of the present disclosure are based upon a virtual fixed 3-reel/1-line triple, double or single combination read from left to right, although any order and 4, 5 and 6 reel-type and multi-line configurations may be constructed.

Predetermined finite tier option shoes of total discount percentage awards determine its number of scale events (e.g., 10-tier shoe contains 30250 FRADA outcomes 550 scale events each consisting of 55 accumulative discount percentage awards).

Virtual fixed reel-type stacks 1 & 3 (outside) may be hierarchically identical while virtual fixed reel-type stack 2 (center) may be non-hierarchical forming the number of FRADA triple, double and single virtual symbolic combinations of finite probabilities within the total tier option shoes as follows:

### 3-Tier Shoe

| Tier Level | Fixed Reel | Triple | Double | Single | Total | |
|---|---|---|---|---|---|---|
| A | 1-1-1 | 1 | 5 | 12 | 18 | 18 Scales |
| B | 2-1-2 | 4 | 8 | 24 | 36 | of |
| C | 3-1-3 | 9 | 9 | 36 | 54 | 6 Discount |

| | | | | | |
|---|---|---|---|---|---|
| Total Discount Awards | 14 | 22 | 72 | 108 | Awards |

### 4-Tier Shoe

| | | | | | | |
|---|---|---|---|---|---|---|
| A | 1-1-1 | 1 | 9 | 30 | 40 | 40 Scales |
| B | 2-1-2 | 4 | 16 | 60 | 80 | of |
| C | 3-1-3 | 9 | 21 | 90 | 120 | 10 Discount |
| D | 4-1-4 | 16 | 24 | 120 | 160 | Awards |

| | | | | |
|---|---|---|---|---|
| Total Discount Awards | 30 | 70 | 300 | 400 |

### 5-Tier Shoe

| | | | | | | |
|---|---|---|---|---|---|---|
| A | 1-1-1 | 1 | 14 | 60 | 75 | 75 Scales |
| B | 2-1-2 | 4 | 26 | 120 | 150 | of |
| C | 3-1-3 | 9 | 36 | 180 | 225 | 15 Discount |
| D | 4-1-4 | 16 | 44 | 240 | 300 | Awards |
| E | 5-1-5 | 25 | 50 | 300 | 375 | |

| | | | | |
|---|---|---|---|---|
| Total Discount Awards | 55 | 170 | 900 | 1125 |

### 6-Tier Shoe

| | | | | | | |
|---|---|---|---|---|---|---|
| A | 1-1-1 | 1 | 20 | 105 | 126 | 126 Scales |
| B | 2-1-2 | 4 | 38 | 210 | 252 | of |
| C | 3-1-3 | 9 | 54 | 315 | 378 | 12 Discount |
| D | 4-1-4 | 16 | 68 | 420 | 504 | Awards |
| E | 5-1-5 | 25 | 80 | 525 | 630 | |
| F | 6-1-6 | 36 | 90 | 630 | 756 | |

| | | | | |
|---|---|---|---|---|
| Total Discount Awards | 91 | 350 | 2205 | 2646 |

### 7-Tier Shoe

| | | | | | | |
|---|---|---|---|---|---|---|
| A | 1-1-1 | 1 | 27 | 168 | 196 | 196 Scales |
| B | 2-1-2 | 4 | 52 | 336 | 392 | of |
| C | 3-1-3 | 9 | 75 | 504 | 588 | 28 Discount |
| D | 4-1-4 | 16 | 96 | 672 | 784 | Awards |
| E | 5-1-5 | 25 | 115 | 840 | 980 | |
| F | 6-1-6 | 36 | 132 | 1008 | 1176 | |
| G | 7-1-7 | 49 | 147 | 1176 | 1372 | |

| | | | | |
|---|---|---|---|---|
| Total Discount | 140 | 644 | 4704 | 5488 |
| Awards | | | | |

### 8-Tier Shoe

| | | | | | | |
|---|---|---|---|---|---|---|
| A | 1-1-1 | 1 | 35 | 252 | 288 | 288 Scales |
| B | 2-1-2 | 4 | 68 | 504 | 576 | of |
| C | 3-1-3 | 9 | 99 | 756 | 864 | 36 Discount |
| D | 4-1-4 | 16 | 128 | 1008 | 1152 | Awards |
| E | 5-1-5 | 25 | 155 | 1260 | 1440 | |
| F | 6-1-6 | 36 | 180 | 1512 | 1728 | |
| G | 7-1-7 | 49 | 203 | 1764 | 2016 | |
| H | 8-1-8 | 64 | 224 | 2016 | 2304 | |

| | | | | |
|---|---|---|---|---|
| Total Discount | 204 | 1092 | 9072 | 10368 |
| Awards | | | | |

### 9-Tier Shoe

| | | | | | | |
|---|---|---|---|---|---|---|
| A | 1-1-1 | 1 | 44 | 360 | 405 | 405 Scales |
| B | 2-1-2 | 4 | 86 | 720 | 810 | of |
| C | 3-1-3 | 9 | 126 | 1080 | 1215 | 45 Discount |
| D | 4-1-4 | 16 | 164 | 1440 | 1620 | Awards |
| E | 5-1-5 | 25 | 200 | 1800 | 2025 | |
| F | 6-1-6 | 36 | 234 | 2160 | 2430 | |
| G | 7-1-7 | 49 | 266 | 2520 | 2835 | |
| H | 8-1-8 | 54 | 296 | 2880 | 3240 | |
| I | 9-1-9 | 81 | 324 | 3240 | 3645 | |

| | | | | |
|---|---|---|---|---|
| Total Discount | 285 | 1740 | 16200 | 18225 |
| Awards | | | | |

### 10-Tier Shoe

| | | | | | | |
|---|---|---|---|---|---|---|
| A | 1-1-1 | 1 | 54 | 495 | 550 | 550 Scales |
| B | 2-1-2 | 4 | 106 | 990 | 1100 | of |
| C | 3-1-3 | 9 | 156 | 1485 | 1650 | 55 Discount |
| D | 4-1-4 | 16 | 204 | 1980 | 2200 | Awards |
| E | 5-1-5 | 25 | 250 | 2475 | 2750 | |
| F | 6-1-6 | 36 | 294 | 2970 | 3300 | |
| G | 7-1-7 | 49 | 336 | 3465 | 3850 | |
| H | 8-1-8 | 64 | 376 | 3960 | 4400 | |
| I | 9-1-9 | 81 | 414 | 4455 | 4950 | |
| J | 10-1-10 | 100 | 450 | 4950 | 5500 | |

| | | | | |
|---|---|---|---|---|
| Total Discount | 385 | 2640 | 27225 | 30250 |
| Awards | | | | |

Starting from the bottom tier level the number of random selected discount percentage awards within each tier level are summed up to provide an exact evenly distributed number per tier level according to hierarchical FRADA rankings ascending to the top tier levels single and last additional award finalizing the total discount percentage award credited towards final pay amount or cashback on pre-paid amount. Triples return the highest discount percentage awards, followed by doubles then singles returning the lowest discount percentage awards within each tier level. The cash scale starts in the ‘weighed down’ tilt (pay meter) position and counter scales back with each tier level till arriving at the top tier level and final discount percentage award. The device counter scale speed rate is quick (e.g., 10 tiers takes the maximum 55 split second or 10 timed eye-catching movements on the cash scale pay amount, discount % and cashback meters displaying a smooth counter-tilt movement). The discount percentage awards range between 0.2%-100%, wherein for example, the guaranteed minimum discount percentage for the 10-tier shoe is 2.02% with a definite completed shoe return to player discount percentage of 5.45%.

The number of predetermined fixed reel finite probability discount percentage award distributions are determined by tier levels. For example, in the above 10-tier version the bottom tier level T will provide the collective sum of 10 discount percentage awards from a total of 5500, tier level ‘I’ will provide the collective sum of 9 discount percentage awards from a total of 4950, tier level ‘H’ will provide the collective sum of 8 discount percentage awards from a total of 4400, tier level ‘G’ will provide the collective sum of 7 discount percentage awards from a total of 3850, tier level ‘F’ will provide the collective sum of 6 discount percentage awards from a total of 3300, tier level ‘E’ will provide the collective sum of 5 discount percentage awards from a total of 2750, tier level ‘D’ will provide the collective sum of 4 discount percentage awards from a total of 2200, tier level ‘C’ will provide the collective sum of 3 discount percentage awards from a total of 1650, tier level ‘B’ will provide the collective sum of 2 discount percentage awards from a total of 1100 and tier level ‘A’ will provide 1 discount percentage award from a total of 550 (top discount percentage award hit frequency) for a total of 55 accumulated discount percentage awards to provide the final discount sum amount. The completed shoe is reshuffled or replaced with the next shoe maintaining a seamless continuous mode.

A, B, C, D, E, F, G, H, I & J are the tier levels and also represent fixed virtual reel symbolic combination hierarchies (FRADA) determining all fixed virtual symbolic combination discount percentage award outcomes (e.g., A-A-A, the top discount percentage award virtual triple symbol combination, A-A-J a virtual double symbol combination and A-D-A a virtual single symbol combination etc.) thus, the first read letter (left) symbol indicates the tier level within the tier option pyramid scaling method.

The virtual symbols determine the triple, double and single one (1) discount percentage award line combinations within a tier level beginning with ‘A’ from left to right and so on throughout all tier levels. Thus, the 10-tier 3-reel/1-line fixed reel configuration consists of A×1 virtual symbol, B×2, C×3, D×4, E×5, F×6, G×7, H×8, I×9 and J×10 adds up to 55 symbols on each of the hierarchical outside fixed reels (1 & 3) and 1 of each symbol adds up to 10 symbols on the non-hierarchical central fixed reel (2) providing a 55×10×55 FRADA total of 30250 predetermined fixed discount percentage awards packaged into 550 scales.

All tiered discount percentage awards (FRADA) shoe structures are in the same format as the 10-tier shoe previously explained according to the number of tiers in a scale event providing a finite probability shoe cycle of all fixed virtual symbol combination discount percentage award round disbursements certifying definite return to player percentages upon completion. After completion of the shoe/deal cycle it is reshuffled or replaced with a newly assembled shoe of predetermined fixed reel outcomes. Scales are denomination, total purchase and/or wager or pre-paid set limit (e.g., $10, $20, $100) or set limit parameters (e.g., $20-$30, $30-$40, $40-$50 etc.) dependent. No set limit or set limit parameter mixing within a shoe.

Following are the qualified (e.g., set limits) discount percentage awards (FRADA) finite probability math analysis (100% hit frequency) of complete tier option shoes and tier level discount percentage award distributions and hit frequencies:

3-Tier Fixed Reel Award Distribution Algorithm Discount % Table:

| Tier | #Awards | Triple % | Double % | Single % | Return % |
|---|---|---|---|---|---|
| A | 1 | 30 | 6 | 2.5 | 5 |
| B | 2 | 7.5 | 3.75 | 1.25 | 5 |
| C | 3 | 3.33 | 3.33 | 0.83 | 5 |
| Totals | 6 | — | — | — | 15 |

Accumulated discount percentage awards determined by FRADA guarantee the minimum cashback percentage per scale and certify the definite cashback percentage per shoe/deal. Thus, Tier A will provide 1×2.5%+Tier B will provide 2×1.25% (2.5)+Tier C will provide 3×0.83% (2.5)=a cashback total of 7.5% from 6 accumulated single discount percentage awards. The maximum possible discount is gaged from the ‘triple’ awards wherein Tier A may provide 1×30%+Tier B may provide 2×7.5% (15)+Tier C may provide 3×3.33% (10)=a cashback total of 55%. The definite discount is 15% from the assignment and elimination of all 18 scales within the 3-tier shoe of 108 discount percentage awards.

Math Analysis (total deal cycle is 108/6 awards=18 scales@$100 limit=$1800 coin-in).

| Tier A (1) | Hits | Hit Rate | Hit % | $Cashback | Total $CB | Cashback % |
|---|---|---|---|---|---|---|
| Triple | 1 | 108 | 0.0093 | 30 | 30 | 1.67 |
| Double | 5 | 21.6 | 0.0463 | 6 | 30 | 1.67 |
| Single | 12 | 9 | 0.1111 | 2.5 | 30 | 1.67 |
| Total | 18 | 6 | 0.1667 | | 90 | 5 |

| Tier B (2) | Hits | Hit Rate | Hit % | $Cashback | Total $CB | Cashback % |
|---|---|---|---|---|---|---|
| Triple | 4 | 27 | 0.0370 | 7.5 | 30 | 1.67 |
| Double | 8 | 13.5 | 0.0741 | 3.75 | 30 | 1.67 |
| Single | 24 | 4.5 | 0.2222 | 1.25 | 30 | 1.67 |
| Total | 36 | 3 | 0.3333 | | 90 | 5 |

| Tier C (3) | Hits | Hit Rate | Hit % | $Cashback | Total $CB | Cashback % |
|---|---|---|---|---|---|---|
| Triple | 9 | 12 | 0.0833 | 3.33 | 30 | 1.67 |
| Double | 9 | 12 | 0.0833 | 3.33 | 30 | 1.67 |
| Single | 36 | 3 | 0.3333 | 0.83 | 30 | 1.67 |
| Total | 54 | 2 | 0.3000 | | 90 | 5 |
| Totals | 108 | 1 | 1.0000 | | 270 | 15 |

4-Tier Fixed Reel Award Distribution Algorithm Discount % Table:

| Tier | #Awards | Triple % | Double % | Single % | Return % |
|---|---|---|---|---|---|
| A | 1 | 40 | 4.44 | 1.33 | 3 |
| B | 2 | 10 | 2.5 | 0.67 | 3 |
| C | 3 | 4.44 | 1.9 | 0.44 | 3 |
| D | 4 | 2.5 | 1.67 | 0.33 | 3 |
| Totals | 10 | — | — | — | 12 |

Accumulated discount percentage awards determined by FRADA guarantee the minimum cashback percentage per scale and certify the definite cashback percentage per shoe/deal. Thus, Tier A will provide 1×1.33%+Tier B will provide 2×0.67% (1.33)+Tier C will provide 3×0.44% (1.33)+Tier D will provide 4×0.33% (1.33)=a cashback total of 5.33% from 10 accumulated single discount percentage awards. The maximum possible discount is gaged from the ‘triple’ awards wherein Tier A may provide 1×40%+Tier B may provide 2×10% (20)+Tier C may provide 3×4.44% (13.32)+Tier D may provide 4×2.5% (10)=a cashback total of 83.32%. The definite discount is 12% from the assignment and elimination of all 40 scales within the 4-tier shoe of 400 discount percentage awards.

Math Analysis (total deal cycle is 400/10 awards=40 scales@$100 set limit=$4000 coin-in).

| Tier A (1) | Hits | Hit Rate | Hit % | $Cashback | Total $CB | Cashback % |
|---|---|---|---|---|---|---|
| Triple | 1 | 400 | 0.0025 | 40 | 40 | 1.00 |
| Double | 9 | 44.44 | 0.0225 | 4.44 | 40 | 1.00 |
| Single | 30 | 13.33 | 0.0750 | 1.33 | 40 | 1.00 |
| Total | 40 | 10.00 | 0.1000 | | 120 | 3 |

| Tier B (2) | Hits | Hit Rate | Hit % | $Cashback | Total $CB | Cashback % |
|---|---|---|---|---|---|---|
| Triple | 4 | 100 | 0.0100 | 10 | 40 | 1.00 |
| Double | 16 | 25 | 0.0400 | 2.5 | 40 | 1.00 |
| Single | 60 | 6.67 | 0.1500 | 0.67 | 40 | 1.00 |
| Total | 80 | 5.00 | 0.2000 | | 120 | 3 |

| Tier C (3) | Hits | Hit Rate | Hit % | $Cashback | Total $CB | Cashback % |
|---|---|---|---|---|---|---|
| Triple | 9 | 44.44 | 0.0225 | 4.44 | 40 | 1.00 |
| Double | 21 | 19.05 | 0.0525 | 1 1.9 | 40 | 1.00 |
| Single | 90 | 4.44 | 0.2250 | 0.44 | 40 | 1.00 |
| Total | 120 | 3.33 | 0.3000 | | 120 | 3 |

| Tier D (4) | Hits | Hit Rate | Hit % | $Cashback | Total $CB | Cashback % |
|---|---|---|---|---|---|---|
| Triple | 16 | 25 | 0.0400 | 2.5 | 40 | 1.00 |
| Double | 24 | 16.67 | 0.0600 | 1.67 | 40 | 1.00 |
| Single | 120 | 3.33 | 0.3000 | 0.33 | 40 | 1.00 |
| Total | 160 | 2.50 | 0.4000 | | 120 | 3 |
| Grand | 400 | 1.00 | 1.00 | | 480 | 12 |

5-Tier Fixed Reel Award Distribution Algorithm Discount % Table:

| Tier | #Awards | Triple % | Double % | Single % | Return % |
|---|---|---|---|---|---|
| A | 1 | 50 | 3.57 | 0.83 | 2 |
| B | 2 | 12.5 | 1.92 | 0.42 | 2 |
| C | 3 | 5.56 | 1.39 | 0.28 | 2 |
| D | 4 | 3.13 | 1.14 | 0.21 | 2 |
| E | 5 | 2 | 1 | 0.17 | 2 |
| Totals | 15 | — | — | — | 10 |

Accumulated discount percentage awards determined by FRADA guarantee the minimum cashback percentage per scale and certify the definite cashback percentage per shoe/deal. Thus, Tier A will provide 1×0.83%+Tier B will provide 2×0.42% (0.84)+Tier C will provide 3×0.28% (0.84)+Tier D will provide 4×0.21% (0.83)+Tier E will provide 5×0.17% (0.83)=a cashback total of 4.17% from 15 accumulated single discount percentage awards. The maximum possible discount is gaged from the ‘triple’ awards wherein Tier A may provide 1×50%+Tier B may provide 2×12.5% (25)+Tier C may provide 3×5.56% (16.68)+Tier D may provide 4×3.13% (12.52)+Tier E may provide 5×2% (10)=a cashback total of 114.2% (note; 100% is the maximum top discount percentage award). The definite discount is 10% from the assignment and elimination of all 75 scales within the 5-tier shoe of 1125 discount percentage awards.

Math Analysis (total deal cycle is 1125/15 awards=75 scales@$100 set limit=$7500 coin-in).

| Tier A | | Hit | | | Total | Cashback |
|---|---|---|---|---|---|---|
| (1) | Hits | Rate | Hit % | $Cashback | $CB | % |
| Triple | 1 | 1125 | 0.0009 | 50 | 50 | 0.67 |
| Double | 14 | 80.36 | 0.0124 | 3.57 | 50 | 0.67 |
| Single | 60 | 18.75 | 0.0533 | 0.83 | 50 | 0.67 |
| Total | 75 | 15 | 0.0667 | | 150 | 2 |

| Tier B | | Hit | | | Total | Cashback |
|---|---|---|---|---|---|---|
| (2) | Hits | Rate | Hit % | $Cashback | $CB | % |
| Triple | 4 | 281.25 | 0.0036 | 12.5 | 50 | 0.67 |
| Double | 26 | 43.27 | 0.0231 | 1.92 | 50 | 0.67 |
| Single | 120 | 9.38 | 0.1067 | 0.42 | 50 | 0.67 |
| Total | 80 | 5.00 | 0.1333 | | 150 | 2 |

| Tier C | | Hit | | | Total | Cashback |
|---|---|---|---|---|---|---|
| (3) | Hits | Rate | Hit % | $Cashback | $CB | % |
| Triple | 9 | 125 | 0.0080 | 5.56 | 50 | 0.67 |
| Double | 36 | 31.25 | 0.0320 | 1.39 | 50 | 0.67 |
| Single | 180 | 6.25 | 0.1600 | 0.28 | 50 | 0.67 |
| Total | 120 | 3.33 | 0.2000 | | 150 | 2 |

| Tier D | | Hit | | | Total | Cashback |
|---|---|---|---|---|---|---|
| (4) | Hits | Rate | Hit % | $Cashback | $CB | % |
| Triple | 16 | 70.31 | 0.0142 | 3.13 | 50 | 0.67 |
| Double | 44 | 25.57 | 0.0391 | 1.14 | 50 | 0.67 |
| Single | 240 | 4.69 | 0.2133 | 0.21 | 50 | 0.67 |
| Total | 300 | 3.75 | 0.2667 | | 150 | 2 |

| Tier E | | Hit | | | Total | Cashback |
|---|---|---|---|---|---|---|
| (5) | Hits | Rate | Hit % | $Cashback | $CB | % |
| Triple | 25 | 45 | 0.0222 | 2 | 50 | 0.67 |
| Double | 50 | 22.50 | 0.0444 | 1 | 50 | 0.67 |
| Single | 300 | 3.75 | 0.2667 | 0.17 | 50 | 0.67 |
| Total | 375 | 3 | 0.3333 | | 150 | 2 |
| Grand | 1125 | 1.00 | 1.0000 | | 750 | 10 |

6-Tier Fixed Reel Award Distribution Algorithm Discount % Table:

| Tier | #Awards | Triple % | Double % | Single % | Return % |
|---|---|---|---|---|---|
| A | 1 | 60 | 3 | 0.57 | 1.43 |
| B | 2 | 15 | 1.58 | 0.29 | 1.43 |
| C | 3 | 6.67 | 1.11 | 0.19 | 1.43 |
| D | 4 | 3.75 | 0.88 | 0.14 | 1.43 |
| E | 5 | 2.4 | 0.75 | 0.11 | 1.43 |
| F | 6 | 1.67 | 0.67 | 0.1 | 1.43 |
| Totals | 21 | — | — | — | 8.57 |

Accumulated discount percentage awards determined by FRADA guarantee the minimum cashback percentage per scale and certify the definite cashback percentage per shoe/deal. Thus, Tier A will provide 1×0.57%+Tier B will provide 2×0.29% (0.58)+Tier C will provide 3×0.19% (0.57)+Tier D will provide 4×0.14% (0.56)+Tier E will provide 5×0.11% (0.55)+Tier F will provide 6×0.1% (60)=a cashback total of 3.43% from 21 accumulated single discount percentage awards. The maximum possible discount is gaged from the ‘triple’ awards wherein Tier A may provide 1×60%+Tier B may provide 2×15% (30)+Tier C may provide 3×6.67% (20)+Tier D may provide 4×3.75% (15)+Tier E may provide 5×2.4% (12)+Tier F may provide 6×1.67 (10)=a cashback total of 147% (note; 100% is the maximum top discount percentage award). The definite discount is 8.57% from the assignment and elimination of all 126 scales within the 6-tier shoe of 2646 discount percentage awards.

Math Analysis (total deal cycle is 2646/21 awards=126 scales@$100 set limit=$12600 coin-in).

| Tier A | | Hit | | | Total | Cashback |
|---|---|---|---|---|---|---|
| (1) | Hits | Rate | Hit % | $Cashback | $CB | % |
| Triple | 1 | 2646 | 0.0004 | 60 | 60 | 0.48 |
| Double | 20 | 132.3 | 0.0076 | 3 | 60 | 0.48 |
| Single | 105 | 25.2 | 0.0397 | 0.57 | 60 | 0.48 |
| Total | 126 | 21 | 0.0476 | | 180 | 1.43 |

| Tier B | | Hit | | | Total | Cashback |
|---|---|---|---|---|---|---|
| (2) | Hits | Rate | Hit % | $Cashback | $CB | % |
| Triple | 4 | 661.5 | 0.0015 | 15 | 60 | 0.48 |
| Double | 38 | 69.63 | 0.0144 | 1.58 | 60 | 0.48 |
| Single | 210 | 12.6 | 0.0794 | 0.29 | 60 | 0.48 |
| Total | 252 | 10.5 | 0.0952 | | 180 | 1.43 |

| Tier C | | Hit | | | Total | Cashback |
|---|---|---|---|---|---|---|
| (3) | Hits | Rate | Hit % | $Cashback | $CB | % |
| Triple | 9 | 294 | 0.0034 | 6.67 | 60 | 0.48 |
| Double | 54 | 49 | 0.0204 | 1.11 | 60 | 0.48 |
| Single | 315 | 8.4 | 0.1190 | 0.19 | 60 | 0.48 |
| Total | 378 | 7 | 0.1429 | | 180 | 1.43 |

| Tier D | | Hit | | | Total | Cashback |
|---|---|---|---|---|---|---|
| (4) | Hits | Rate | Hit % | $Cashback | $CB | % |
| Triple | 16 | 165.38 | 0.0060 | 3.75 | 60 | 0.48 |
| Double | 68 | 38.91 | 0.0257 | 0.88 | 60 | 0.48 |
| Single | 420 | 6.3 | 0.1587 | 0.14 | 60 | 0.48 |
| Total | 504 | 5.25 | 0.1905 | | 180 | 1.43 |

| Tier E | | Hit | | | Total | Cashback |
|---|---|---|---|---|---|---|
| (5) | Hits | Rate | Hit % | $Cashback | $CB | % |
| Triple | 25 | 105.84 | 0.0094 | 2.4 | 60 | 0.48 |
| Double | 80 | 33.08 | 0.0302 | 0.75 | 60 | 0.48 |
| Single | 525 | 5.04 | 0.1984 | 0.11 | 60 | 0.48 |
| Total | 630 | 4.2 | 0.2381 | | 180 | 1.43 |

| Tier F | | Hit | | | Total | Cashback |
|---|---|---|---|---|---|---|
| (6) | Hits | Rate | Hit % | $Cashback | $CB | % |
| Triple | 36 | 73.5 | 0.0136 | 1.67 | 60 | 0.48 |
| Double | 90 | 29.4 | 0.0340 | 0.67 | 60 | 0.48 |
| Single | 630 | 4.2 | 0.2381 | 0.10 | 60 | 0.48 |
| Total | 756 | 3.5 | 0.2857 | | 180 | 1.43 |
| Grand | 2646 | 1.00 | 1.0000 | | 1080 | 8.57 |

7-Tier Fixed Reel Award Distribution Algorithm Discount % Table

| Tier | #Awards | Triple % | Double % | Single % | Return % |
|---|---|---|---|---|---|
| A | 1 | 70 | 2.59 | 0.42 | 1.07 |
| B | 2 | 17.5 | 1.35 | 0.21 | 1.07 |
| C | 3 | 7.78 | 0.93 | 0.14 | 1.07 |
| D | 4 | 4.38 | 0.73 | 0.10 | 1.07 |
| E | 5 | 2.8 | 0.61 | 0.08 | 1.07 |
| F | 6 | 1.94 | 0.53 | 0.07 | 1.07 |
| G | 7 | 1.43 | 0.48 | 0.06 | 1.07 |
| Totals | 28 | — | — | — | 7.5 |

Accumulated discount percentage awards determined by FRADA guarantee the minimum cashback percentage per scale and certify the definite cashback percentage per shoe/deal. Thus, Tier A will provide 1×0.42%+Tier B will provide 2×0.21% (0.42)+Tier C will provide 3×0.14% (0.42)+Tier D will provide 4×0.10% (0.40)+Tier E will provide 5×0.08% (0.40)+Tier F will provide 6×0.07% (0.42)+Tier G will provide 7×0.06% (0.42)=a cashback total of 2.92% from 28 accumulated single discount percentage awards. The maximum possible discount is gaged from the ‘triple’ awards wherein Tier A may provide 1×70%+Tier B may provide 2×17.5% (35)+Tier C may provide 3×7.78% (23.34)+Tier D may provide 4×4.38% (17.92)+Tier E may provide 5×2.8% (14)+Tier F may provide 6×1.94 (11.64)+Tier G may provide 7×1.43% (10)=a cashback total of 181.9% (note; 100% is the maximum top discount percentage award). The definite discount is 7.5% from the assignment and elimination of all 196 scales within the 7-tier shoe of 5488 discount percentage awards

Math Analysis (total deal cycle is 5488/28 awards=196 scales@$100 set limit=$19600 coin-in).

| | | | | | Total | |
|---|---|---|---|---|---|---|
| Tier A (1) | Hits | Hit Rate | Hit % | $Cashback | $CB | Cashback % |
| Triple | 1 | 5488 | 0.0002 | 70 | 70 | 0.36 |
| Double | 27 | 203.26 | 0.0049 | 2.59 | 70 | 0.36 |
| Single | 168 | 32.67 | 0.0306 | 0.42 | 70 | 0.36 |
| Total | 196 | 28 | 0.0357 | | 210 | 1.07 |

| | | | | | Total | |
|---|---|---|---|---|---|---|
| Tier B (2) | Hits | Hit Rate | Hit % | $Cashback | $CB | Cashback % |
| Triple | 4 | 1372 | 0.0007 | 17.5 | 70 | 0.36 |
| Double | 52 | 105.54 | 0.0095 | 1.35 | 70 | 0.36 |
| Single | 336 | 16.33 | 0.0612 | 0.21 | 70 | 0.36 |
| Total | 392 | 14 | 0.0714 | | 210 | 1.07 |

| | | | | | Total | |
|---|---|---|---|---|---|---|
| Tier C (3) | Hits | Hit Rate | Hit % | $Cashback | $CB | Cashback % |
| Triple | 9 | 609.78 | 0.0016 | 7.78 | 70 | 0.36 |
| Double | 75 | 73.17 | 0.0137 | 0.93 | 70 | 0.36 |
| Single | 504 | 16.33 | 0.0612 | 0.14 | 70 | 0.36 |
| Total | 588 | 9.33 | 0.1071 | | 210 | 1.07 |

| | | | | | Total | |
|---|---|---|---|---|---|---|
| Tier D (4) | Hits | Hit Rate | Hit % | $Cashback | $CB | Cashback % |
| Triple | 16 | 343 | 0.0029 | 4.38 | 70 | 0.36 |
| Double | 96 | 57.17 | 0.0175 | 0.73 | 70 | 0.36 |
| Single | 672 | 8.17 | 0.1224 | 0.10 | 70 | 0.36 |
| Total | 784 | 7 | 0.1429 | | 210 | 1.07 |

| | | | | | Total | |
|---|---|---|---|---|---|---|
| Tier E (5) | Hits | Hit Rate | Hit % | $Cashback | $CB | Cashback % |
| Triple | 25 | 219.52 | 0.0046 | 2.8 | 70 | 0.36 |
| Double | 115 | 47.72 | 0.0210 | 0.61 | 70 | 0.36 |
| Single | 840 | 6.53 | 0.0612 | 0.08 | 70 | 0.36 |
| Total | 980 | 5.6 | 0.1786 | | 210 | 1.07 |

| | | | | | Total | |
|---|---|---|---|---|---|---|
| Tier F (6) | Hits | Hit Rate | Hit % | $Cashback | $CB | Cashback % |
| Triple | 36 | 152.44 | 0.0066 | 1.94 | 70 | 0.36 |
| Double | 132 | 41.58 | 0.0241 | 0.53 | 70 | 0.36 |
| Single | 1008 | 5.44 | 0.1837 | 0.07 | 70 | 0.36 |
| Total | 1176 | 4.67 | 0.2143 | | 210 | 1.07 |

| | | | | | Total | |
|---|---|---|---|---|---|---|
| Tier G (7) | Hits | Hit Rate | Hit % | $Cashback | $CB | Cashback % |
| Triple | 49 | 112 | 0.0089 | 1.43 | 70 | 0.36 |
| Double | 147 | 37.33 | 0.0268 | 0.48 | 70 | 0.36 |
| Single | 1176 | 4.67 | 0.2143 | 0.06 | 70 | 0.36 |
| Total | 1372 | 4 | 0.2500 | | 210 | 1.07 |
| Grand | 5488 | 1.00 | 1.0000 | | 1470 | 7.5 |

8-Tier Fixed Reel Award Distribution Algorithm Discount % Table:

| Tier | #Awards | Triple % | Double % | Single % | Return % |
|---|---|---|---|---|---|
| A | 1 | 80 | 2.29 | 0.32 | 0.83 |
| B | 2 | 20 | 1.18 | 0.16 | 0.83 |
| C | 3 | 8.89 | 0.81 | 0.11 | 0.83 |
| D | 4 | 5 | 0.63 | 0.08 | 0.83 |
| E | 5 | 3.2 | 0.52 | 0.06 | 0.83 |
| F | 6 | 2.22 | 0.44 | 0.05 | 0.83 |
| G | 7 | 1.63 | 0.39 | 0.05 | 0.83 |
| H | 8 | 1.25 | 0.36 | 0.04 | 0.83 |
| Totals | 36 | — | — | — | 6.67 |

Accumulated discount percentage awards determined by FRADA guarantee the minimum cashback percentage per scale and certify the definite cashback percentage per shoe/deal. Thus, Tier A will provide 1×0.32%+Tier B will provide 2×0.16% (0.32)+Tier C will provide 3×0.11% (0.33)+Tier D will provide 4×0.08% (0.32)+Tier E will provide 5×0.06% (0.30)+Tier F will provide 6×0.05% (0.30)+Tier G will provide 7×0.05% (0.35)+Tier H will provide 8×0.04% (0.32)=a cashback total of 2.54% from 28 accumulated single discount percentage awards. The maximum possible discount is gaged from the ‘triple’ awards wherein Tier A may provide 1×80%+Tier B may provide 2×20% (40)+Tier C may provide 3×8.89% (26.67)+Tier D may provide 4×5% (20)+Tier E may provide 5×3.2% (16)+Tier F may provide 6×2.22 (13.32)+Tier G may provide 7×1.63% (11.41)+Tier H may provide 8×1.25% (10)=a cashback total of 217.4% (note; 100% is the maximum top discount percentage award). The definite discount is 6.67% from the assignment and elimination of all 288 scales within the 8-tier shoe of 5488 discount awards.

Math Analysis (total deal cycle is 10368/36 awards=288 scales@$100 set limit=$28800 coin-in).

| | | | | | Total | |
|---|---|---|---|---|---|---|
| Tier A (1) | Hits | Hit Rate | Hit % | $Cashback | $CB | Cashback % |
| Triple | 1 | 10368 | 0.0001 | 80 | 80 | 0.28 |
| Double | 35 | 296.23 | 0.0034 | 2.29 | 80 | 0.28 |
| Single | 252 | 41.14 | 0.0243 | 0.32 | 80 | 0.28 |
| Total | 288 | 36 | 0.0278 | | 240 | 0.83 |

| | | | | | Total | |
|---|---|---|---|---|---|---|
| Tier B (2) | Hits | Hit Rate | Hit % | $Cashback | $CB | Cashback % |
| Triple | 4 | 2592 | 0.0004 | 20 | 80 | 0.28 |
| Double | 68 | 152.47 | 0.0066 | 1.18 | 80 | 0.28 |
| Single | 504 | 20.57 | 0.0486 | 0.16 | 80 | 0.28 |
| Total | 576 | 18 | 0.0556 | | 240 | 0.83 |

| | | | | | Total | |
|---|---|---|---|---|---|---|
| Tier C (3) | Hits | Hit Rate | Hit % | $Cashback | $CB | Cashback % |
| Triple | 9 | 1152 | 0.0009 | 8.89 | 80 | 0.28 |
| Double | 99 | 104.73 | 0.0095 | 0.81 | 80 | 0.28 |
| Single | 756 | 13.71 | 0.0729 | 0.11 | 80 | 0.28 |
| Total | 864 | 12 | 0.0833 | | 240 | 0.83 |

| | | | | | Total | |
|---|---|---|---|---|---|---|
| Tier D (4) | Hits | Hit Rate | Hit % | $Cashback | $CB | Cashback % |
| Triple | 16 | 648 | 0.0015 | 5 | 80 | 0.28 |
| Double | 128 | 81 | 0.0123 | 0.63 | 80 | 0.28 |
| Single | 1008 | 10.29 | 0.0972 | 0.32 | 80 | 0.28 |
| Total | 1152 | 9 | 0.1111 | | 240 | 0.83 |

| | | | | | Total | |
|---|---|---|---|---|---|---|
| Tier E (5) | Hits | Hit Rate | Hit % | $Cashback | $CB | Cashback % |
| Triple | 25 | 414.72 | 0.0024 | 3.2 | 80 | 0.28 |
| Double | 155 | 66.89 | 0.0149 | 0.52 | 80 | 0.28 |
| Single | 1260 | 8.23 | 0.1215 | 0.06 | 80 | 0.28 |
| Total | 1440 | 7.2 | 0.1389 | | 240 | 0.83 |

| | | | | | Total | |
|---|---|---|---|---|---|---|
| Tier F (6) | Hits | Hit Rate | Hit % | $Cashback | $CB | Cashback % |
| Triple | 36 | 288 | 0.0035 | 2.22 | 80 | 0.28 |
| Double | 180 | 57.6 | 0.0174 | 0.44 | 80 | 0.28 |
| Single | 1512 | 6.86 | 0.1458 | 0.05 | 80 | 0.28 |
| Total | 1728 | 6 | 0.1667 | | 240 | 0.83 |

| | | | | | Total | |
|---|---|---|---|---|---|---|
| Tier G (7) | Hits | Hit Rate | Hit % | $Cashback | $CB | Cashback % |
| Triple | 49 | 211.59 | 0.0047 | 1.63 | 80 | 0.28 |
| Double | 203 | 51.07 | 0.0196 | 0.39 | 80 | 0.28 |
| Single | 1764 | 5.88 | 0.1701 | 0.05 | 80 | 0.28 |
| Total | 2016 | 5.14 | 0.1944 | | 240 | 0.83 |

| | | | | | Total | |
|---|---|---|---|---|---|---|
| Tier H (8) | Hits | Hit Rate | Hit % | $Cashback | $CB | Cashback % |
| Triple | 64 | 162 | 0.0062 | 1.25 | 80 | 0.28 |
| Double | 224 | 46.29 | 0.0216 | 0.36 | 80 | 0.28 |
| Single | 2016 | 5.14 | 0.1944 | 0.04 | 80 | 0.28 |
| Total | 2304 | 4.5 | 0.2222 | | 240 | 0.83 |
| Grand | 10368 | 1.00 | 1.0000 | | 1920 | 6.67 |

9-Tier Fixed Reel Award Distribution Algorithm Discount % Table:

| Tier | #Awards | Triple % | Double % | Single % | Return % |
|---|---|---|---|---|---|
| A | 1 | 90 | 2.05 | 0.25 | 0.67 |
| B | 2 | 22.5 | 1.05 | 0.13 | 0.67 |
| C | 3 | 10 | 0.71 | 0.08 | 0.67 |
| D | 4 | 5.63 | 0.55 | 0.06 | 0.67 |
| E | 5 | 3.6 | 0.45 | 0.05 | 0.67 |
| F | 6 | 2.5 | 0.38 | 0.04 | 0.67 |
| G | 7 | 1.84 | 0.34 | 0.04 | 0.67 |
| H | 8 | 1.41 | 0.30 | 0.03 | 0.67 |
| I | 9 | 1.11 | 0.28 | 0.03 | 0.67 |
| Totals | 45 | — | — | — | 6.00 |

Accumulated discount percentage awards determined by FRADA guarantee the minimum cashback percentage per scale and certify the definite cashback percentage per shoe/deal. Thus, Tier A will provide 1×0.25%+Tier B will provide 2×0.13% (0.26)+Tier C will provide 3×0.08% (0.24)+Tier D will provide 4×0.06% (0.24)+Tier E will provide 5×0.05% (0.25)+Tier F will provide 6×0.04% (0.24)+Tier G will provide 7×0.04% (0.28)+Tier H will provide 8×0.03% (0.24)+Tier I will provide 9×0.03% (0.27)=a cashback total of 2.25% from 45 accumulated single discount percentage awards. The maximum possible discount is gaged from the ‘triple’ awards wherein Tier A may provide 1×90%+Tier B may provide 2×22.5% (45)+Tier C may provide 3×10% (30)+Tier D may provide 4×5.63% (22.5)+Tier E may provide 5×3.6% (18)+Tier F may provide 6×2.5 (15)+Tier G may provide 7×1.84% (12.9)+Tier H may provide 8×1.41% (11.3)+Tier I may provide 9×1.11% (10)=a cashback total of 254.7% (note; 100% is the maximum top discount percentage award). The definite discount is 6% from the assignment and elimination of all 405 scales within the 9-tier shoe of 18225 discount percentage awards.

Math Analysis (total deal cycle is 18225/45 awards=405 scales@$100 set limit=$40500 coin-in).

| | | Hit | | | Total | |
|---|---|---|---|---|---|---|
| Tier A (1) | Hits | Rate | Hit % | $Cashback | $CB | Cashback % |
| Triple | 1 | 18225 | 0.00005 | 90 | 90 | 0.22 |
| Double | 44 | 414.2 | 0.0024 | 2.05 | 90 | 0.22 |
| Single | 360 | 50.63 | 0.0198 | 0.25 | 90 | 0.22 |
| Total | 405 | 45 | 0.0222 | | 270 | 0.67 |

| | | Hit | | | Total | |
|---|---|---|---|---|---|---|
| Tier B (2) | Hits | Rate | Hit % | $Cashback | $CB | Cashback % |
| Triple | 4 | 4556.25 | 0.0002 | 22.5 | 90 | 0.22 |
| Double | 86 | 211.92 | 0.0047 | 1.05 | 90 | 0.22 |
| Single | 720 | 25.3 | 0.0395 | 0.13 | 90 | 0.22 |
| Total | 810 | 22.5 | 0.0444 | | 270 | 0.67 |

| | | Hit | | | Total | |
|---|---|---|---|---|---|---|
| Tier C (3) | Hits | Rate | Hit % | $Cashback | $CB | Cashback % |
| Triple | 9 | 2025 | 0.0005 | 10 | 90 | 0.22 |
| Double | 126 | 144.64 | 0.0069 | 0.71 | 90 | 0.22 |
| Single | 1080 | 16.88 | 0.0593 | 0.08 | 90 | 0.22 |
| Total | 1215 | 15 | 0.0667 | | 270 | 0.67 |

| | | Hit | | | Total | |
|---|---|---|---|---|---|---|
| Tier D (4) | Hits | Rate | Hit % | $Cashback | $CB | Cashback % |
| Triple | 16 | 1139.06 | 0.0009 | 5.63 | 90 | 0.22 |
| Double | 164 | 111.13 | 0.0090 | 0.55 | 90 | 0.22 |
| Single | 1440 | 12.66 | 0.0790 | 0.06 | 90 | 0.22 |
| Total | 1620 | 11.25 | 0.0889 | | 270 | 0.67 |

| | | Hit | | | Total | |
|---|---|---|---|---|---|---|
| Tier E (5) | Hits | Rate | Hit % | $Cashback | $CB | Cashback % |
| Triple | 25 | 729 | 0.0014 | 3.6 | 90 | 0.22 |
| Double | 200 | 91.13 | 0.0110 | 0.45 | 90 | 0.22 |
| Single | 1800 | 10.13 | 0.0988 | 0.05 | 90 | 0.22 |
| Total | 2025 | 9 | 0.1111 | | 270 | 0.67 |

| | | Hit | | | Total | |
|---|---|---|---|---|---|---|
| Tier F (6) | Hits | Rate | Hit % | $Cashback | $CB | Cashback % |
| Triple | 36 | 506.25 | 0.0020 | 2.5 | 90 | 0.22 |
| Double | 234 | 77.88 | 0.0128 | 0.38 | 90 | 0.22 |
| Single | 2160 | 8.44 | 0.1185 | 0.04 | 90 | 0.22 |
| Total | 2430 | 7.5 | 0.1333 | | 270 | 0.67 |

| | | Hit | | | Total | |
|---|---|---|---|---|---|---|
| Tier G (7) | Hits | Rate | Hit % | $Cashback | $CB | Cashback % |
| Triple | 49 | 371.94 | 0.0027 | 1.84 | 90 | 0.22 |
| Double | 266 | 68.52 | 0.0146 | 0.34 | 90 | 0.22 |
| Single | 2520 | 7.23 | 0.1383 | 0.04 | 90 | 0.22 |
| Total | 2835 | 6.43 | 0.1556 | | 270 | 0.67 |

| | | Hit | | | Total | |
|---|---|---|---|---|---|---|
| Tier H (8) | Hits | Rate | Hit % | $Cashback | $CB | Cashback % |
| Triple | 64 | 284.77 | 0.0035 | 1.41 | 90 | 0.22 |
| Double | 296 | 61.57 | 0.0162 | 0.30 | 90 | 0.22 |
| Single | 2880 | 6.33 | 0.1580 | 0.03 | 90 | 0.22 |
| Total | 3240 | 5.63 | 0.1778 | | 270 | 0.67 |

| | | Hit | | | Total | |
|---|---|---|---|---|---|---|
| Tier H (8) | Hits | Rate | Hit % | $Cashback | $CB | Cashback % |
| Triple | 81 | 225 | 0.0044 | 1.11 | 90 | 0.22 |
| Double | 324 | 56.25 | 0.0178 | 0.28 | 90 | 0.22 |
| Single | 3240 | 5.63 | 0.1778 | 0.03 | 90 | 0.22 |
| Total | 3645 | 5 | 0.2000 | | 270 | 0.67 |
| Grand | 18225 | 1.00 | 1.0000 | | 2430 | 6.00 |

10-Tier Fixed Reel Award Distribution Algorithm Discount % Table:

| Tier | #Awards | Triple % | Double % | Single % | Return % |
|---|---|---|---|---|---|
| A | 1 | 100 | 1.85 | 0.20 | 0.55 |
| B | 2 | 25 | 0.94 | 0.10 | 0.55 |
| C | 3 | 11.11 | 0.64 | 0.07 | 0.55 |
| D | 4 | 6.25 | 0.49 | 0.05 | 0.55 |
| E | 5 | 4 | 0.40 | 0.04 | 0.55 |
| F | 6 | 2.78 | 0.34 | 0.03 | 0.55 |
| G | 7 | 2.04 | 0.30 | 0.03 | 0.55 |
| H | 8 | 1.56 | 0.27 | 0.03 | 0.55 |
| I | 9 | 1.23 | 0.24 | 0.02 | 0.55 |
| J | 10 | 1 | 0.22 | 0.02 | 0.55 |
| Totals | 55 | — | — | — | 5.45 |

Accumulated discount percentage awards determined by FRADA guarantee the minimum cashback percentage per scale and certify the definite cashback percentage per shoe/deal. Thus, Tier A will provide 1×0.20%+Tier B will provide 2×0.10% (0.20)+Tier C will provide 3×0.07% (0.21)+Tier D will provide 4×0.05% (0.20)+Tier E will provide 5×0.04% (0.20)+Tier F will provide 6×0.03% (0.18)+Tier G will provide 7×0.03% (0.21)+Tier H will provide 8×0.03% (0.24)+Tier I will provide 9×0.02% (0.18)+Tier J will provide 10×0.02% (0.20)=a cashback total of 2.02% from 55 accumulated single discount percentage awards. The maximum possible discount is gaged from the ‘triple’ awards wherein Tier A may provide 1×100%+Tier B may provide 2×25% (50)+Tier C may provide 3×11.11% (33)+Tier D may provide 4×6.25% (26)+Tier E may provide 5×4% (20)+Tier F may provide 6×2.78 (16.7)+Tier G may provide 7×2.04% (14.3)+Tier H may provide 8×1.56% (12.5)+Tier I may provide 9×1.23% (11)+Tier J may provide 10×1% (0.10)=a cashback total of 273.5% (note; 100% is the maximum top discount percentage award). The definite discount is 5.45% from the assignment and elimination of all 550 scales within the 10-tier shoe of 30250 discount percentage awards.

Math Analysis (total deal cycle is 30250/55 awards=550 scales@$100 set limit=$55000 coin-in).

| | | Hit | | | Total | |
|---|---|---|---|---|---|---|
| Tier A (1) | Hits | Rate | Hit % | $Cashback | $CB | Cashback % |
| Triple | 1 | 30250 | 0.00003 | 100 | 100 | 0.18 |
| Double | 54 | 560.19 | 0.00179 | 1.85 | 100 | 0.18 |
| Single | 495 | 61.11 | 0.01636 | 0.20 | 100 | 0.18 |
| Total | 550 | 55 | 0.01818 | | 300 | 0.55 |

| | | Hit | | | Total | |
|---|---|---|---|---|---|---|
| Tier B (2) | Hits | Rate | Hit % | $Cashback | $CB | Cashback % |
| Triple | 4 | 7562.5 | 0.0001 | 25 | 100 | 0.18 |
| Double | 106 | 285.38 | 0.0035 | 0.94 | 100 | 0.18 |
| Single | 990 | 30.56 | 0.0327 | 0.10 | 100 | 0.18 |
| Total | 1100 | 27.50 | 0.0364 | | 300 | 0.55 |

| | | Hit | | | Total | |
|---|---|---|---|---|---|---|
| Tier C (3) | Hits | Rate | Hit % | $Cashback | $CB | Cashback % |
| Triple | 9 | 3361.11 | 0.0003 | 11.11 | 100 | 0.18 |
| Double | 156 | 193.91 | 0.0052 | 0.64 | 100 | 0.18 |
| Single | 1485 | 20.37 | 0.0491 | 0.07 | 100 | 0.18 |
| Total | 1650 | 18.33 | 0.0545 | | 300 | 0.55 |

| | | Hit | | | Total | |
|---|---|---|---|---|---|---|
| Tier D (4) | Hits | Rate | Hit % | $Cashback | $CB | Cashback % |
| Triple | 16 | 1890.63 | 0.0005 | 6.25 | 100 | 0.18 |
| Double | 204 | 148.28 | 0.0067 | 0.49 | 100 | 0.18 |
| Single | 1980 | 15.28 | 0.0655 | 0.05 | 100 | 0.18 |
| Total | 2200 | 13.75 | 0.0727 | | 300 | 0.55 |

| | | Hit | | | Total | |
|---|---|---|---|---|---|---|
| Tier E (5) | Hits | Rate | Hit % | $Cashback | $CB | Cashback % |
| Triple | 25 | 1210 | 0.0008 | 4 | 100 | 0.18 |
| Double | 250 | 121 | 0.0083 | 0.40 | 100 | 0.18 |
| Single | 2475 | 12.22 | 0.0818 | 0.04 | 100 | 0.18 |
| Total | 2750 | 11 | 0.0909 | | 300 | 0.55 |

| | | Hit | | | Total | |
|---|---|---|---|---|---|---|
| Tier F (6) | Hits | Rate | Hit % | $Cashback | $CB | Cashback % |
| Triple | 36 | 840.28 | 0.0012 | 2.78 | 100 | 0.18 |
| Double | 294 | 102.89 | 0.0097 | 0.34 | 100 | 0.18 |
| Single | 2970 | 10.19 | 0.0982 | 0.03 | 100 | 0.18 |
| Total | 3300 | 9.17 | 0.1091 | | 300 | 0.55 |

| | | | | | Total | |
|---|---|---|---|---|---|---|
| Tier G (7) | Hits | Hit Rate | Hit % | $Cashback | $CB | Cashback % |
| Triple | 49 | 617.35 | 0.0016 | 2.04 | 100 | 0.18 |
| Double | 336 | 90.03 | 0.0111 | 0.30 | 100 | 0.18 |
| Single | 3465 | 8.73 | 0.1145 | 0.03 | 100 | 0.18 |
| Total | 3850 | 7.86 | 0.1273 | | 300 | 0.55 |

| | | | | | Total | |
|---|---|---|---|---|---|---|
| Tier H (8) | Hits | Hit Rate | Hit % | $Cashback | $CB | Cashback % |
| Triple | 64 | 472.66 | 0.0021 | 1.56 | 100 | 0.18 |
| Double | 376 | 80.45 | 0.0124 | 0.27 | 100 | 0.18 |
| Single | 3960 | 7.64 | 0.1309 | 0.03 | 100 | 0.18 |
| Total | 4400 | 6.88 | 0.1455 | | 300 | 0.55 |

| | | | | | Total | |
|---|---|---|---|---|---|---|
| Tier I (9) | Hits | Hit Rate | Hit % | $Cashback | $CB | Cashback % |
| Triple | 81 | 373.46 | 0.0027 | 1.23 | 100 | 0.18 |
| Double | 414 | 73.07 | 0.0137 | 0.24 | 100 | 0.18 |
| Single | 4455 | 6.79 | 0.1473 | 0.02 | 100 | 0.18 |
| Total | 4950 | 6.11 | 0.1636 | | 300 | 0.55 |

| Tier J | | | | | Total | Cashback |
|---|---|---|---|---|---|---|
| (10) | Hits | Hit Rate | Hit % | $Cashback | $CB | % |
| Triple | 100 | 302.50 | 0.0033 | 1.00 | 100 | 0.18 |
| Double | 450 | 67.22 | 0.0149 | 0.22 | 100 | 0.18 |
| Single | 4950 | 6.11 | 0.1636 | 0.02 | 100 | 0.18 |
| Total | 5500 | 5.5 | 0.1818 | | 300 | 0.55 |
| Grand | 30250 | 1.00 | 1.00 | | 3000 | 5.45 |

Discount award sizing is tier option and level determined according to FRADA virtual fixed-reel symbolic outcomes (e.g., triple, double or single combination lines read from left to right).

### Qualifier:

1. Meets denomination, purchase, wager or pre-paid set limit (e.g., $20, $50, $100 etc.) or set limit parameters (e.g., $10-$20, $20-$30, $30-$40 etc.)
2. Triggers [symbol] ASH$ [symbol] ALE$ discount percentage awards (e.g., min 2%-max 100%)
3. Wins an instant discounted pay amount or cashback on a pre-paid amount
   Qualifier wins a predetermined randomly packaged multi-discount percentage awards tier option scale triggered at a point-of-sale terminal. The set limits or parameters represent the true cost of a purchase, wager or pre-paid product, event or service offered by the vendor or host wherein the discount percentage award are an operational expense (marketing) in the same manner as loyalty rewards, compliments, vouchers, freebies etc. Cashback awards may be saved for future redemption with the issuing vendor or group.

In a wagering environment the player may qualify by a set limit deposit triggering a discount percentage award (e.g., $100 deposited in a slot machine wins a 20% discount of $20). Therefore, if the game is played at $1 a spin, then after 100 spins regardless of wins and losses, only then will the cashback be credited to the players slot machine or gaming communication device while cashing out before 100 spins forfeits the cashback award. The discount percentage awards may be calculated, just as jackpots, bonuses and free spins are currently, to arrive at the return to player (RTP) of a game, or an additional award gaming feature to improve player entertainment and participation.

Additionally, the effect of delayed cashbacks may be an assistance to aid at-risk behavior harm prevention and minimization vendor and host responsibility policies. Implemented as a wager risk mitigation method wherein a cashback (e.g., 20% or more) is automatically ticketed forcing the player into performing a cash redemption only (behavioral change).

### Mutual Benefits:

100% hit frequency
Guaranteed minimum discount % or cashback
Certified definite RTP discount % and cashback
Chance to win big discounts or a totally free purchase, wager or service
Instant, saved or forced cashback redemption
Increase revenue through qualifying set purchase and wager limit parameters

The Following Show Class 1 Tier Thresholds for Various Embodiments.

| | | | Top | | | |
|---|---|---|---|---|---|---|
| Tier | #Exchanges | #Entries | Award | +Average | −Average | Return % |
| 1 | 300 | 30 | $10+ | $1.50 | $0.70 | 97.50 |
| 2 | 600 | 60 | $20+ | $1.51 | $0.70 | 97.77 |
| 3 | 900 | 90 | $30+ | $1.52 | $0.70 | 97.89 |
| 4 | 1200 | 120 | $40+ | $1.53 | $0.70 | 98.04 |
| 5 | 1500 | 150 | $50+ | $1.54 | $0.70 | 98.08 |
| 6 | 1800 | 180 | $60+ | $1.54 | $0.70 | 98.25 |
| 7 | 2100 | 210 | $70+ | $1.55 | $0.70 | 98.30 |
| 8 | 2400 | 240 | $80+ | $1.56 | $0.70 | 98.43 |
| 9 | 2700 | 270 | $100+ | $1.57 | $0.70 | 98.72 |
| 10 | 3000 | 300 | $120+ | $1.58 | $0.70 | 99.40 |

Competition for exchange credits are funded by a community of players entry fees e.g., $10 wherein each player accumulates 10×$1 exchange awards to build a win total. Starting at ‘Tier 1’ 300 exchanges divided by 10 will require a minimum of 30 entries to initiate a competition and start the timer (e.g., 5 min) allowing more players to enter and build the community distribution pool. An entry number provides access to each player where they see their awards accumulate on their device. The whole competition event takes seconds to deliver. Entries caught between tier threshold when competition starts will be refunded e.g., 220 entries (caught between Tier 7 & 8 means 210 play and last 10 are refunded or pushed). Multiple entries e.g., 3 entries @ $30 will buy 30 exchange awards to build a win total.

| $120 | | | | $100 | | | |
|---|---|---|---|---|---|---|---|
| $80 | $70 | $60 | $50 | $40 | $30 | $20 | $10 |
| $5 | $3 | $2 | $1.8 | $1.7 | $1.6 | $1.5 | $1.4 |
| $1.3 | $1.2 | $1.1 | $0.9 | $0.8 | $0.7 | $0.6 | $0.5 |

Awards based on $1 per trade for 1+ and 1− win outcomes. Players are assigned a first random predetermined positive/negative ratio (e.g., 4 positive/6 negative) delivering negative wins second followed by positive wins third building to a win total. Delivery is via a storage media device (SMD) with 3 queues of random predetermined positive/negative hit ratio assignments, negative wins (2/3) and positive wins (1/3). Triple randomization delivery method.

### Credit Meter Trade & Exchange Competitions on Electronic Gaming Machines.

| | | | Top | | | |
|---|---|---|---|---|---|---|
| Tier | #Exchanges | #Entries | Award | +Average | −Average | Return % |
| 1 | 300 | 30 | 1000+ | 150 | 70 | 97.50 |
| 2 | 600 | 60 | 2000+ | 151 | 70 | 97.77 |
| 3 | 900 | 90 | 3000+ | 152 | 70 | 97.89 |
| 4 | 1200 | 120 | 4000+ | 153 | 70 | 98.04 |
| 5 | 1500 | 150 | 5000+ | 154 | 70 | 98.08 |
| 6 | 1800 | 180 | 6000+ | 154 | 70 | 98.25 |
| 7 | 2100 | 210 | 7000+ | 155 | 70 | 98.30 |
| 8 | 2400 | 240 | 8000+ | 156 | 70 | 98.43 |
| 9 | 2700 | 270 | 10000+ | 157 | 70 | 98.72 |
| 10 | 3000 | 300 | 12000+ | 158 | 70 | 99.40 |

Awards based on 100 credits per trade (e.g., @10¢ a credit).

| 12000 | | | | 10000 | | | |
|---|---|---|---|---|---|---|---|
| 8000 | 7000 | 6000 | 5000 | 4000 | 3000 | 2000 | 1000 |
| 500 | 300 | 200 | 180 | 170 | 160 | 150 | 140 |
| 130 | 120 | 110 | 90 | 80 | 70 | 60 | 50 |

Certification—Class III math and equipment are independently certified for sale or placement in a licensed gaming establishment. Volatility of a game will generally rank e.g., from low (more frequent small wins) to high (less frequent big wins). These are 2 examples of certifying the return to player percentage (RTP %) on modern and popular Class III multi-line slot games with the same payback;

| | Volatility Index | | | |
|---|---|---|---|---|
| | 95% Confidence = 30.94 (A) | | 95% Confidence = 13.13 (B) | |
| # Games | Low | High | Low | High |
| Played | RTP % | RTP % | RTP % | RTP % |
| 1000 | 5.84 | 189.84 | 50.48 | 133.52 |
| 10000 | 61.06 | 122.94 | 78.87 | 105.13 |
| 100000 | 82.22 | 101.78 | 87.84 | 96.15 |
| 1000000 | 88.91 | 95.09 | 90.69 | 93.31 |
| 10000000 | 91.02 | 92.98 | 91.58 | 92.42 |

Win/Loss proposition. Observation of the average player duration in any one session of play on a slot machine is around 30-40 minutes (1000 games played). The above indexes show that unless the wins are big or adequate on table (A) the first 1000 credits will decrease rapidly and on table (B) which is a lot less volatile slowing the decline on the first 1000 credits producing many small wins. Time on device is what most players perceive as value for money and the method of the present invention is to provide more time without penalizing the house who facilitates for a per trade fee (e.g., 0.005%-0.025%).

The credit trade and exchange method of the present invention is a stable index;

Stable Index
100% Confidence = 1

| # Entries | Low RTP % | High RTP % |
|---|---|---|
| Trade Average | 70.00 | 158.00 |
| 300 (Tier 10) | 99.0 | 99.0 |

The math is important as all configurations and tiers must return high percentages to players, as exemplified in the following tabulation of tiers:
Class I Gaming definition (social with minimal prizes):
Tier (PAYS & HITS) & Ratio (+Win/−Win) Configurations;
Tier 1;

| PAYS | | 10 | 5 | 3 | 2 | 1.8 | 1.7 | 1.6 | 1.5 |
|---|---|---|---|---|---|---|---|---|---|
| HITS | | 1 | 1 | 2 | 5 | 6 | 4 | 4 | 11 |
| TOTAL PAY | | 10 | 5 | 6 | 10 | 10.8 | 6.8 | 6.4 | 16.5 |
| 1.4 | 1.3 | 1.2 | 1.1 | 0.9 | 0.8 | 0.7 | 0.6 | 0.5 | Totals |
| 7 | 12 | 39 | 8 | 40 | 40 | 40 | 40 | 40 | 300 |
| 9.8 | 15.6 | 46.8 | 8.8 | 36 | 32 | 28 | 24 | 20 | 292.5 |

RTP 97.50%

Ratio 1;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 1 | 1 | 1 | 2 | 2 | 2 | 1 | 5 | 7 | 4 | 4 | 30 |

RTP 97.50%

Tier 2;

| 0 | 20 | 10 | 5 | 3 | 2 | 1.8 | 1.7 | 1.6 | 1.5 |
|---|---|---|---|---|---|---|---|---|---|
| 0 | 1 | 1 | 2 | 6 | 5 | 6 | 7 | 0 | 25 |
| 0 | 20 | 10 | 10 | 18 | 10 | 10.8 | 11.9 | 0 | 37.5 |
| 1.4 | 1.3 | 1.2 | 1.1 | 0.9 | 0.8 | 0.7 | 0.6 | 0.5 | Totals |
| 3 | 34 | 90 | 20 | 80 | 80 | 80 | 80 | 80 | 600 |
| 4.2 | 44.2 | 108 | 22 | 72 | 64 | 56 | 48 | 40 | 586.6 |

RTP 97.77%

Ratio 2;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 1 | 1 | 1 | 3 | 3 | 5 | 6 | 18 | 10 | 6 | 6 | 60 |

RTP 97.77%

Tier 3;

| 0 | 30 | 10 | 5 | 3 | 2 | 1.8 | 1.7 | 1.6 | 1.5 |
|---|---|---|---|---|---|---|---|---|---|
| 0 | 1 | 1 | 4 | 9 | 10 | 0 | 11 | 18 | 23 |
| 0 | 30 | 10 | 20 | 27 | 20 | 0 | 18.7 | 28.8 | 34.5 |
| 1.4 | 1.3 | 1.2 | 1.1 | 0.9 | 0.8 | 0.7 | 0.6 | 0.5 | Totals |
| 18 | 38 | 137 | 30 | 120 | 120 | 120 | 120 | 120 | 900 |
| 25.2 | 49.4 | 164.4 | 33 | 108 | 96 | 84 | 72 | 60 | 880.9 |

RTP 97.88%

Ratio 1;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 1 | 2 | 2 | 4 | 5 | 8 | 8 | 21 | 26 | 6 | 7 | 90 |

RTP 97.88%

Tier 4;

| 40 | 20 | 10 | 5 | 3 | 2 | 1.8 | 1.7 | 1.6 | 1.5 |
|---|---|---|---|---|---|---|---|---|---|
| 1 | 1 | 1 | 3 | 7 | 15 | 10 | 15 | 12 | 44 |
| 40 | 20 | 10 | 15 | 21 | 30 | 18 | 25.5 | 19.2 | 66 |
| 1.4 | 1.3 | 1.2 | 1.1 | 0.9 | 0.8 | 0.7 | 0.6 | 0.5 | Totals |
| 22 | 27 | 197 | 45 | 160 | 160 | 160 | 160 | 160 | 1200 |
| 30.8 | 35.1 | 236.4 | 49.5 | 144 | 128 | 112 | 96 | 80 | 1176.5 |

RTP 98.04%

Ratio 4;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 2 | 2 | 3 | 5 | 8 | 9 | 11 | 23 | 43 | 6 | 8 | 120 |

RTP 98.04%

Tier 5;

| 50 | 20 | 10 | 5 | 3 | 2 | 1.8 | 1.7 | 1.6 | 1.5 |
|---|---|---|---|---|---|---|---|---|---|
| 1 | 1 | 1 | 5 | 12 | 16 | 16 | 17 | 14 | 50 |
| 50 | 20 | 10 | 25 | 36 | 32 | 28.8 | 28.9 | 22.4 | 75 |
| 1.4 | 1.3 | 1.2 | 1.1 | 0.9 | 0.8 | 0.7 | 0.6 | 0.5 | Totals |
| 27 | 30 | 253 | 57 | 200 | 200 | 200 | 200 | 200 | 1500 |
| 37.8 | 39 | 303.6 | 62.7 | 180 | 160 | 140 | 120 | 100 | 1471.2 |

RTP 98.08%

Ratio 5;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 2 | 3 | 4 | 5 | 8 | 12 | 16 | 35 | 38 | 18 | 9 | 150 |

RTP 98.08%

Tier 6;

| 60 | 20 | 10 | 5 | 3 | 2 | 1.8 | 1.7 | 1.6 | 1.5 |
|---|---|---|---|---|---|---|---|---|---|
| 1 | 1 | 1 | 7 | 10 | 38 | 8 | 18 | 23 | 48 |
| 60 | 20 | 10 | 35 | 30 | 76 | 14.4 | 30.6 | 36.8 | 72 |
| 1.4 | 1.3 | 1.2 | 1.1 | 0.9 | 0.8 | 0.7 | 0.6 | 0.5 | Totals |
| 38 | 78 | 272 | 57 | 240 | 240 | 240 | 240 | 240 | 1800 |
| 53.2 | 101.4 | 326.4 | 62.7 | 216 | 192 | 168 | 144 | 120 | 1768.5 |

RTP 98.25%

Ratio 6;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 2 | 3 | 4 | 6 | 9 | 12 | 24 | 52 | 30 | 29 | 9 | 180 |

RTP 98.25%

Tier 7;

| 70 | 20 | 10 | 5 | 3 | 2 | 1.8 | 1.7 | 1.6 | 1.5 |
|---|---|---|---|---|---|---|---|---|---|
| 1 | 1 | 1 | 7 | 16 | 29 | 10 | 30 | 26 | 80 |
| 70 | 20 | 10 | 35 | 48 | 58 | 18 | 51 | 41.6 | 120 |
| 1.4 | 1.3 | 1.2 | 1.1 | 0.9 | 0.8 | 0.7 | 0.6 | 0.5 | Totals |
| 50 | 100 | 288 | 61 | 280 | 280 | 280 | 280 | 280 | 2100 |
| 70 | 130 | 345.6 | 67.1 | 252 | 224 | 196 | 168 | 140 | 2064.3 |

RTP 98.30%

Ratio 7;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 3 | 4 | 5 | 7 | 9 | 18 | 24 | 56 | 22 | 51 | 11 | 210 |

RTP 98.30%

Tier 8;

| 80 | 20 | 10 | 5 | 3 | 2 | 1.8 | 1.7 | 1.6 | 1.5 |
|---|---|---|---|---|---|---|---|---|---|
| 1 | 1 | 2 | 12 | 15 | 39 | 20 | 10 | 26 | 80 |
| 80 | 20 | 20 | 60 | 45 | 78 | 36 | 17 | 41.6 | 120 |
| 1.4 | 1.3 | 1.2 | 1.1 | 0.9 | 0.8 | 0.7 | 0.6 | 0.5 | Totals |
| 50 | 100 | 363 | 81 | 320 | 320 | 320 | 320 | 320 | 2400 |
| 70 | 130 | 435.6 | 89.1 | 288 | 256 | 224 | 192 | 160 | 2362.3 |

RTP 98.43%

Ratio 8;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 4 | 5 | 6 | 9 | 12 | 16 | 28 | 56 | 25 | 67 | 12 | 240 |

RTP 98.43%

Tier 9;

| 100 | 30 | 20 | 5 | 3 | 2 | 1.8 | 1.7 | 1.6 | 1.5 |
|---|---|---|---|---|---|---|---|---|---|
| 1 | 1 | 1 | 12 | 20 | 27 | 30 | 30 | 27 | 60 |
| 100 | 30 | 20 | 60 | 60 | 54 | 54 | 51 | 43.2 | 90 |
| 1.4 | 1.3 | 1.2 | 1.1 | 0.9 | 0.8 | 0.7 | 0.6 | 0.5 | Totals |
| 90 | 60 | 441 | 100 | 360 | 360 | 360 | 360 | 360 | 2700 |
| 126 | 78 | 529.2 | 110 | 324 | 288 | 252 | 216 | 180 | 2665.4 |

RTP 98.72%

Ratio 9;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 5 | 6 | 7 | 10 | 15 | 18 | 29 | 56 | 26 | 85 | 13 | 270 |

RTP 98.72%

Tier 10;

| 120 | 40 | 20 | 5 | 3 | 2 | 1.8 | 1.7 | 1.6 | 1.5 |
|---|---|---|---|---|---|---|---|---|---|
| 1 | 1 | 1 | 6 | 13 | 43 | 11 | 42 | 31 | 78 |
| 120 | 40 | 20 | 55 | 81 | 82 | 43.2 | 71.4 | 60.8 | 105 |
| 1.4 | 1.3 | 1.2 | 1.1 | 0.9 | 0.8 | 0.7 | 0.6 | 0.5 | Totals |
| 52 | 235 | 376 | 107 | 400 | 400 | 400 | 400 | 400 | 3000 |
| 72.8 | 143 | 570 | 117.7 | 360 | 320 | 280 | 240 | 200 | 2970.0 |

RTP 99.00%

Ratio 10;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 6 | 7 | 8 | 11 | 15 | 18 | 35 | 60 | 54 | 71 | 15 | 300 |

RTP 99.00%

Note; Tier ‘PAYS & HITS’ are configurable, controlling positive/negative ratio (e.g., 33.33%/66.67% or 25%/75%) to create a plurality of awards table options as shown in the variation below.
Tier 10a;

| 200 | 40 | 20 | 10 | 5 | 3 | 2 | 1.8 | 1.7 | 1.6 |
|---|---|---|---|---|---|---|---|---|---|
| 1 | 1 | 2 | 5 | 5 | 15 | 52 | 10 | 40 | 30 |
| 200 | 40 | 40 | 50 | 25 | 45 | 104 | 18 | 68 | 48 |
| 1.5 | 1.4 | 1.3 | 1.2 | 0.9 | 0.8 | 0.7 | 0.6 | 0.5 | Totals |
| 78 | 49 | 169 | 293 | 450 | 450 | 450 | 450 | 450 | 3000 |
| 117 | 68.6 | 219.7 | 351.6 | 405 | 360 | 315 | 270 | 225 | 2969.9 |

RTP 99.00%

Ratio 10a;

+Wins/−Wins

| 10/0 | 9/1 | 8/2 | 7/3 | 6/4 | 5/5 | 4/6 | 3/7 | 2/8 | 1/9 | 0/10 | Total |
|---|---|---|---|---|---|---|---|---|---|---|---|
| 8 | 8 | 8 | 9 | 9 | 9 | 11 | 13 | 82 | 78 | 65 | 300 |

RTP 99.00%

Game Play;
Player credits (e.g., cash, credit) are traded for exchange rate credits (e.g., cash, credit, voucher, discount percentages etc.);
   1. Select Trades (increments of 10)
   2. Exchange distribution commences (entry-initiated start time)
   3. Firstly, a random predetermined +/− ratio (e.g., 3/7) assignment
   4. Secondly, random predetermined negative wins (e.g., 7 awards)
   5. Thirdly, random predetermined positive wins (e.g., 3 awards)
   6. Game over, transfer wins to credits (e.g., =sum of 7 negative wins plus 3 positive wins=60.5)
+Win (Positive)=Pays more than 1 (e.g., 1.1)
−Win (Negative)=Pays less than 1 (e.g., 0.9)
Closed out (failed to qualify)=Refund
Hit Frequency;
   1-2=1 positive win (33.33%) to 2 negative wins (66.67%) top award 120 for 1
   1-3=1 positive win (25%) to 3 negative wins (75%) top award 200 for 1
Tier level entry-initiated start and summary;

| Tier | Entries | Trades | Top Award+ | Fee % |
|---|---|---|---|---|
| 1 | 30 | 300 | 10+ | 2.50 |
| 2 | 60 | 600 | 20+ | 2.23 |
| 3 | 90 | 900 | 30+ | 2.12 |
| 4 | 120 | 1200 | 40+ | 1.96 |
| 5 | 150 | 1500 | 50+ | 1.92 |
| 6 | 180 | 1800 | 60+ | 1.75 |
| 7 | 210 | 2100 | 70+ | 1.70 |
| 8 | 240 | 2400 | 80+ | 1.57 |
| 9 | 270 | 2700 | 100+ | 1.28 |
| 10 | 300 | 3000 | 120+ | 1.00 |
| 10a | 300 | 3000 | 200+ | 1.00 |

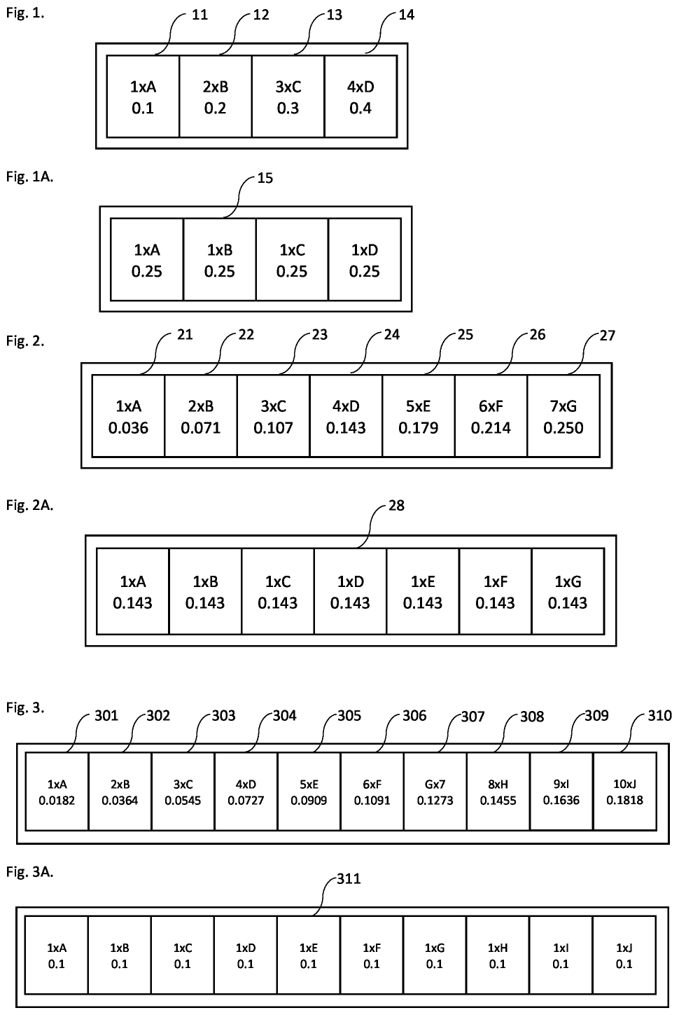

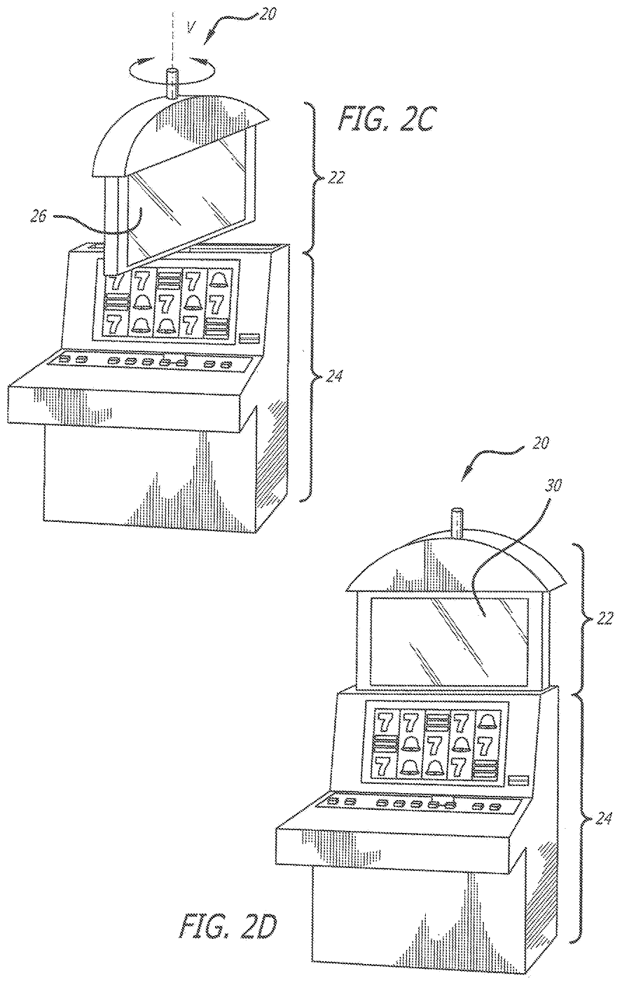

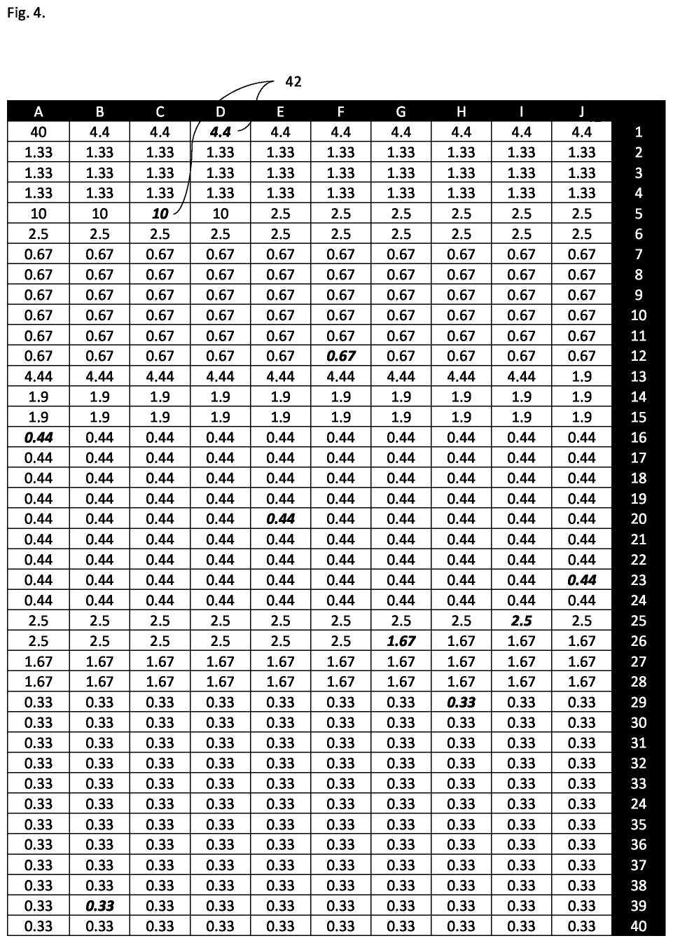

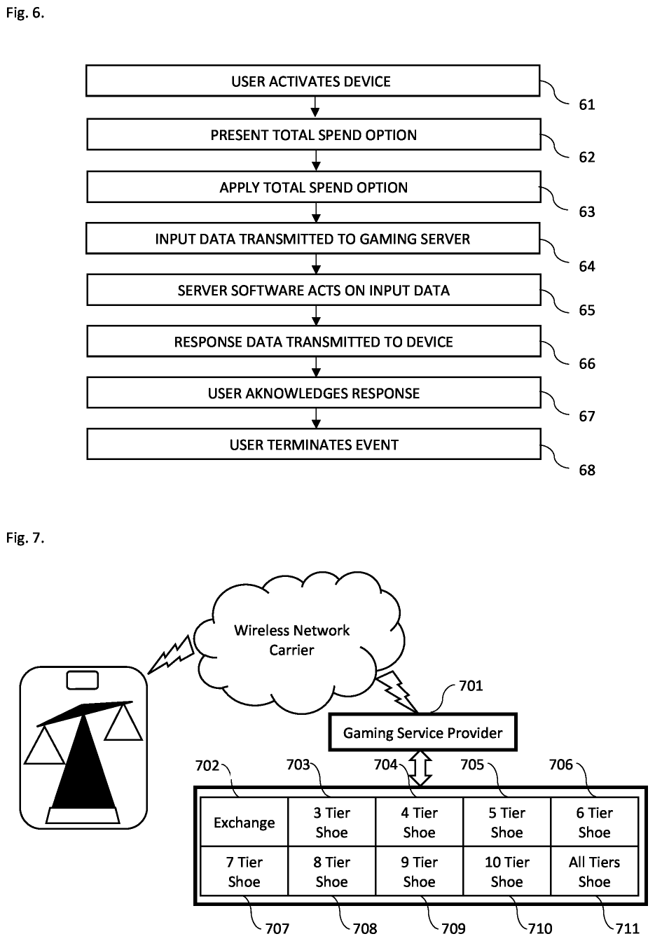

FIG. 1. shows a distribution bar of the hit percentage possibilities of each virtual symbol in a 4-tier fixed reel (reels 1 & 3 outside) 11, 12, 13, and 14 hierarchical structure consisting of 1× virtual symbol ‘A’ (0.1), 2× virtual symbol ‘B’ (0.2), 3× virtual symbol ‘C’ (0.3), and 4× virtual symbol ‘D’ (0.4) creating a 10 virtual symbol hierarchical fixed reel stack. FIG. 1A. shows a distribution bar of the hit percentages of each symbol in a 4-tier fixed reel (reel 2 inside) non-hierarchical structure consisting of 1× virtual symbol ‘A’ (0.25), 1× virtual symbol ‘B’ (0.25), 1× virtual symbol ‘C’ (0.25) and 1× virtual symbol ‘D’ (0.25) creating a 4 virtual symbol non-hierarchical fixed reel stack when combined with virtual fixed reels 1 & 3 creates a 10×4×10 finite cycle (“FRADA”) of 400 awards determined by triple, double and single virtual symbol combinations generating all possible outcomes from a left to right direction across all 3 virtual fixed reels. FIG. 2. shows a distribution bar of the hit percentage possibilities of each virtual symbol in a 7-tier fixed reel (reels 1 & 3 outside) 21, 22, 23, 24, 25, 26 and 27 hierarchical structure consisting of 1× virtual symbol ‘A’ (0.036), 2× virtual symbol ‘B’ (0.071), 3× virtual symbol ‘C’ (0.107), 4× virtual symbol ‘D’ (0.143), 5× virtual symbol ‘E’ (0.179), 6× virtual symbol ‘F’ (0.214) and 7× virtual symbol ‘G’ (0.250) creating a 28 virtual symbol hierarchical fixed reel stack. FIG. 2A. shows a distribution bar of the hit percentages of each virtual symbol in a 7-tier fixed reel (reel 2 inside) 28 non-hierarchical structure consisting of 1× virtual symbol ‘A’ (0.143), 1× virtual symbol ‘B’ (0.143), 1× virtual symbol ‘C’ (0.143), 1× virtual symbol ‘D’ (0.143), 1× virtual symbol ‘E’ (0.143), 1× virtual symbol ‘F’ (0.143) and 1× virtual symbol ‘G’ (0.143) creating a 7 virtual symbol non-hierarchical fixed reel stack when combined with virtual fixed reels 1 & 3 creates a 28×7×28 finite cycle (“FRADA”) of 5488 awards determined by triple, double and single virtual symbol combinations generating all possible outcomes from a left to right direction across all 3 virtual fixed reels. FIG. 3. shows a distribution bar of the hit percentages of each virtual symbol in a 10-tier fixed reel (reels 1 & 3 outside) 301, 302, 303, 304, 305, 306, 307, 308, 309 and 310 hierarchical structure consisting of 1× virtual symbol ‘A’ (0.0182), 2× virtual symbol ‘B’ (0.0364), 3× virtual symbol ‘C’ (0.0545), 4× virtual symbol ‘D’ (0.0727), 5× virtual symbol ‘E’ (0.0909), 6× virtual symbol ‘F’ (0.1091), 7× virtual symbol ‘G’ (0.1273), 8× virtual symbol ‘H’ (0.1455), 9× virtual symbol ‘I’ (0.1636) and 10× virtual symbol ‘J’ (0.1818) creating a 55 virtual symbol hierarchical fixed reel stack. FIG. 3A. shows a distribution bar of the hit percentages of each virtual symbol in a 10-tier fixed reel (reel 2 inside) 311 non-hierarchical structure consisting of 1× virtual symbol ‘A’ (0.1), 1× virtual symbol ‘B’ (0.1), 1× virtual symbol ‘C’ (0.1), 1× virtual symbol ‘D’ (0.1), 1× virtual symbol ‘E’ (0.1), 1× virtual symbol ‘F’ (0.1), 1× virtual symbol ‘G’ (0.1), 1× virtual symbol ‘H’ (0.1), 1× virtual symbol ‘I’ (0.1) and 1× virtual symbol T (0.1) creating a 10 virtual symbol non-hierarchical fixed reel stack when combined with virtual symbol fixed reels 1 & 3 creates a 55×10×55 finite cycle (“FRADA”) of 30250 awards determined by triple, double and single symbol combinations generating all possible outcomes from a left to right direction across all 3 virtual fixed reels. FIG. 4. shows a 4-tier 10×40 grid letters (across) by numbers (down) shoe 41 and the discount managed 100% disbursement of 400 discount percentage awards within the finite probability, highlighting 42 predetermined randomly selected awards through each of the tiers within a single scale (deal) event. There is only 1 discount award per each of the across grid lines although down grid lines may have more than 1 discount award in the same tier. Starting from the bottom, Tier Level D provides the first 4 discount percentage award assignments from grid numbers B39 (0.33) ascending to H29 (0.33), G26 (1.67) and 125 (2.5) for sum total of 4.83% and eliminations from Tier Level D's total of 160 discount percentage award possibilities (leaving a balance of 156), ascending to Tier Level C providing the next 3 discount percentage award assignments J23 (0.44), E20 (0.44) and A16 (0.44), a sum total of 1.32% updating discount to new total (6.15%) and eliminations from Tier Level C's total of 120 discount percentage award possibilities (leaving a tier balance of 117), ascending to Tier Level B providing the next 2 discount percentage award assignments F12 (0.67) and C5 (10) a sum total of 10.67% updating discount to new total (16.82%) and eliminations from Tier Level B's total of 80 award possibilities (leaving a tier balance of 78), ascending to the top and last Tier Level A providing 1 discount percentage award D1 of 4.4% updating to the final accumulated total of 21.22% cashback discount on total purchase and/or wager amount qualified limit, eliminating 1 from 40 discount percentage award possibilities leaving a balance of 39 for the next scale (deal). FIG. 5. Shows the number of tiers 51, the tier level 52, total purchase and/or wager and starting pay meter 53 of $100 weighing scale down, tier level random incremental discount percentage award scale movements starting from the bottom tier ‘E’ 0.83% 54 resulting in cashback $0.83 55 and decreasing the pay meter to $99.17. The next cash scale movement increase is tier ‘D’ to 1.67%, updating cashback to $1.67 decreasing the pay meter to $98.33, tier ‘C’ to 7.78%, updating cashback to $7.78 decreasing the pay meter to $92.22, tier ‘B’ to 10.12%, updating cashback to $10.12 decreasing the pay meter to $89.88, tier ‘A’ to 60.12%, updating cashback to $60.12 decreasing the final pay meter to $39.88 on the original $100 spent or wagered. Delivery will be a smooth seamless scaled eye movement animation from start to finish as the final pay amount is predetermined. FIG. 6. shows the flow chart steps from end user activation 61, to presentation of total purchase and/or wager option 62, applying total purchase and/or wager option 63, input transmission data 64, server acting on input data 65, response data transmission to gaming communication device 66, end user acknowledgement 67 and end user termination of the event 68. FIG. 7. shows the gaming service provider 701 wherein financial exchange transactions 702 are conducted for the purchase of point-of-sale or accumulated-sale discount award tiered shoe 703, 704, 705, 706, 707, 708, 709, 710 and 711 options and content delivery via a wireless network carrier to an end user gaming communication device.

Following are the grid discount percentage award numbering system for all fixed-reel tier structures of the present disclosure including 4, 7 & 10-tier fixed reel stacking examples described in FIGS. 1 & 1A, 2 & 2A, 3 & 3A.

3-Tier 6 awards×18 scales shoe (108 awards) grid random distribution system:

| Tier | Awards | Across | Down | Total |
|---|---|---|---|---|
| A | 1 | A-F | 1-3 | 18 |
| B | 2 | | 4-9 | 36 |
| C | 3 | | 10-18 | 54 |

4-Tier 10 awards×40 scales shoe (400 awards) grid random distribution system:

| Tier | Awards | Across | Down | Total |
|---|---|---|---|---|
| A | 1 | A-J | 1-4 | 40 |
| B | 2 | | 5-12 | 80 |
| C | 3 | | 13-24 | 120 |
| D | 4 | | 25-40 | 160 |

5-Tier 15 awards×75 scales shoe (1125 awards) grid random distribution system:

| Tier | Awards | Across | Down | Total |
|---|---|---|---|---|
| A | 1 | A-O | 1-5 | 75 |
| B | 2 | | 6-15 | 150 |
| C | 3 | | 16-30 | 225 |
| D | 4 | | 31-50 | 300 |
| E | 5 | | 51-75 | 375 |

6-Tier 21 awards×126 scales shoe (2646 awards) grid random numbering system:

| Tier | Awards | Across | Down | Total |
|---|---|---|---|---|
| A | 1 | A-U | 1-6 | 126 |
| B | 2 | | 7-18 | 252 |
| C | 3 | | 19-36 | 378 |
| D | 4 | | 37-60 | 504 |
| E | 5 | | 61-90 | 630 |
| F | 6 | | 91-126 | 756 |

7-Tier 28 awards×196 scales shoe (5488 awards) grid random distribution system:

| Tier | Awards | Across | Down | Total |
|---|---|---|---|---|
| A | 1 | A-AB | 1-7 | 196 |
| B | 2 | | 8-21 | 392 |
| C | 3 | | 22-42 | 588 |
| D | 4 | | 43-70 | 784 |
| E | 5 | | 71-105 | 980 |
| F | 6 | | 106-147 | 1176 |
| G | 7 | | 148-196 | 1372 |

8-Tier 36 awards×288 scales shoe (10368 awards) grid random distribution system:

| Tier | Awards | Across | Down | Total |
|---|---|---|---|---|
| A | 1 | A-AJ | 1-8 | 288 |
| B | 2 | | 9-24 | 576 |
| C | 3 | | 25-48 | 864 |
| D | 4 | | 49-80 | 1152 |
| E | 5 | | 81-120 | 1440 |
| F | 6 | | 121-168 | 1728 |
| G | 7 | | 169-224 | 2016 |
| H | 8 | | 225-288 | 2304 |

9-Tier 45 awards×405 scales shoe (18225 awards) grid random distribution system:

| Tier | Awards | Across | Down | Total |
|---|---|---|---|---|
| A | 1 | A-AS | 1-9 | 405 |
| B | 2 | | 10-27 | 810 |
| C | 3 | | 28-54 | 1215 |
| D | 4 | | 55-90 | 1620 |
| E | 5 | | 91-135 | 2025 |
| F | 6 | | 136-189 | 2835 |
| G | 7 | | 190-252 | 3850 |
| H | 8 | | 253-324 | 3240 |
| I | 9 | | 325-405 | 3645 |

10-Tier 55 awards×550 scales shoe (30250 awards) grid random distribution system:

| Tier | Awards | Across | Down | Total |
|---|---|---|---|---|
| A | 1 | A-BC | 1-10 | 550 |
| B | 2 | | 11-30 | 1100 |
| C | 3 | | 31-60 | 1650 |
| D | 4 | | 61-100 | 2200 |
| E | 5 | | 101-150 | 2750 |
| F | 6 | | 151-210 | 3300 |
| G | 7 | | 211-280 | 3850 |
| H | 8 | | 281-360 | 4400 |
| I | 9 | | 361-450 | 4950 |
| J | 10 | | 451-550 | 5500 |

Discount award assignments are determined by the random distribution of the above across (letters) and down (numbers) system for each tier ensuring that the fixed finite predetermined discount percentage awards are evenly disbursed throughout each tier level avoiding duplication or overlapping of grid assignments and eliminations.

“Discount Percentage Award Manager” controls the discount percentages for every tier's probability distribution and detects the 100% maximum discount percentage award limit voiding any excess additional percentages in a single scale event. The qualifiers' chance objective is to ‘tip’ the scale and win the 100% discount percentage award, but every discount is a free cashback award.

Themes and brands may be used to market the present invention as an alternative marketing strategy to acquisition and retention customer loyalty programs but rather encourage increased purchase and/or wagering with mutual benefits.

FIG. 2C is a perspective view of A gaming machine with the top box rotating; Optionally, the gaming machine 20 includes one or more motion sensors (not shown) or pinch sensors (not shown) to stop the rotation of the top box 22 if an obstruction is in the path of the top box and the display 26. In various embodiments, the sensors may be infrared, optical or radiofrequency sensors. Of course, any type of sensor may be used herein. Additionally, the sensors may be used to stop the rotation of the top box 22 when the top box has achieved its final stopping position as shown in FIG. 2D. According to one embodiment, as shown in FIG. 2D, the back 28 of the top box 22 includes another display 30.

As well known in the slot machine art, the gaming machines may include a plurality of player-activated buttons. These buttons may be used for various functions such as, but not limited to, selecting a wager denomination, selecting a number of games to be played, selecting the wager amount per game, initiating a game, or cashing out money from the gaming machine. The buttons 13 function as input mechanisms and may include mechanical buttons, electromechanical buttons or touch screen buttons. In another embodiment, one input mechanism is a universal button module that provides a dynamic button system adaptable for use with various games, as disclosed in U.S. application Ser. No. 11/106,212, entitled “Universal Button Module”, filed Apr. 14, 2005 and U.S. application Ser. No. 11/223,364, entitled “Universal Button Module”, filed Sep. 9, 2005, which are both hereby incorporated by reference. Additionally, other input devices, such as but not limited to, touch pad, track ball, mouse, switches, toggle switches, are included with the gaming machine to also accept player input. Optionally, a handle 15 may be “pulled” by a player to initiate a slots-based game.

In an alternate embodiment, a cellular phone or other input device (e.g., PDA), separate and apart, from the gaming machine may also be used to input various player choices and information to enhance the player's interactive experience with the gaming machine. Furthermore, inputting information via these devices provides an added level of security as any key presses may be hidden from view. In yet another embodiment, a player may call or send a text message or a short message service (SMS) to the gaming machine.

As further known in the slot machine art, the gaming machines may include a ticket reader/ticket printer slot that is associated with a cashless gaming system (not shown). A single slot may be used for the ticket reader and ticket printer. Accordingly, the same slot 21 may be used to insert and/or issue a ticket. However, in alternate embodiments, separate slots (not shown) may be provided for the ticket acceptor and the ticket printer. In one embodiment, the ticket reader (not shown) of the cashless gaming system is capable of accepting previously printed vouchers, paper currency, promotional coupons, or the like. The ticket printer (not shown) of the cashless gaming system generates vouchers having printed information that includes, but is not limited to, the value of the voucher (i.e., cash-out amount) and a barcode that identifies the voucher.

Additionally, the gaming machines may include a player tracking system. The player tracking system allows a casino to monitor the gaming activities of various players. Additionally, the player tracking system is able to store data relating to a player's gaming habits. That is, a player can accrue player points that depend upon the amount and frequency of their wagers. Casinos can use these player points to compensate the loyal patronage of players. For example, casinos may award or “comp” a player with free meals, room accommodations, tickets to shows, and invitations to casino events and promotional affairs.

Typically, the player tracking system is operatively connected to one or more input components on the gaming machine. These input components include, but are not limited to, a slot for receiving a player tracking card, a keypad or equivalent, an electronic button receptor, a touch screen and the like. The player tracking system may also include a database of all qualified players (i.e., those players who have enrolled in a player rating or point accruing program). Generally, the database for the player tracking system is separate from the gaming machines.

In another embodiment, the gaming machines include an internet connection or other known network connections to link one or more gaming machines together. According to one embodiment, the internet connection is used for web browsing, prize redemption, or access to other gaming or non-gaming information. Additionally, with the various gaming machines in communication with one another (or a system host), the gaming machines may participate in a gaming tournament. In one embodiment, the gaming tournament is a competitive gaming tournament having one (or a few) winners. Alternatively, the gaming tournament is a cooperative gaming tournament where all eligible gaming machines win a particular award.

According to one embodiment, the start of the tournament may be signified by the movement of the top box in a vertical direction. For example, the top box (not shown) may be fashioned to look like a rocket ship with accompanying sound and/or smoke effects. Alternatively, the top box may move incrementally upwards as the tournament progresses. Accordingly, a player may have a visual idea of their relative position in the tournament game based upon the height of the top box.

One of ordinary skill in the art will appreciate that not all gaming machines have all these components and may have other components in addition to, or in lieu of, those components mentioned here. Furthermore, while these components are viewed and described separately, various components may be integrated into a single unit in some embodiments.

A casino gaming system may include one or more gaming machines. In various embodiments, any of the gaming machines may be any type of electronic or mechanical gaming devices, such as, but not limited to, a mechanical reel spinning slot machine, video slot machine, video poker machine, keno machine, video blackjack machine, or a gaming machine offering one or more of the above-described games. Examples include, but are not limited to, the S6000 mechanical reel spinner and the Alpha video slot machine from Bally Technologies, Inc. The gaming machines may act as terminals for interacting with a player playing a casino game. Networking components facilitate communications between the system server and game management units that control displays for carousels of gaming machines 10 across a network. Game management units (GMU's) connect gaming machines to networking components and may be installed in the gaming machine cabinet or external to the gaming machine. The function of the GMU is similar to the function of a network interface card connected to a desktop personal computer (PC). Some GMU's have much greater capability and can perform such tasks as presenting and playing a game using a display (not shown) operatively connected to the GMU. In one embodiment, the GMU is a separate component located outside the gaming machine 10. Alternatively, in another embodiment, the GMU is located within the gaming machine. Optionally, in an alternative embodiment, one or more gaming machines connect directly to a network and are not connected to a GMU.

Furthermore, one or more of the gaming machines 10 includes one or more data repositories for storing data. Examples of information stored by the gaming machines 10 include, but are not limited to, accounting data, maintenance history information, short and/or long-term play data, real-time play data, and sound data. The sound data may include, but is not limited to, audio files, sound clips, way files, mp3 files and sound files saved in various other formats. Furthermore, each gaming machine 10 comprises an audio system (not shown) for outputting sound.

The gaming machines 10 are connected via a network to a network bridge 120, which is used for networking, routing and polling gaming machines, including slot machines. The network bridge 120 connects to a back-end system 112. Optionally, the gaming machines 10 may connect to the network via a network rack 122, which provides for a few numbers of connections to the back-end system 112. Both network bridge 120 and network rack 122 may be classified as middleware and facilitate communications between the back-end system 112 and the game management units 126. The network bridges 120 and network rack 122 may comprise data repositories for storing network performance data. Such performance data may be based on network traffic and other network related information. Optionally, the network bridge 120 and the network rack 122 may be interchangeable components. For example, in one embodiment, a casino gaming system may comprise only network bridges and no network racks. Alternatively, in another embodiment, a casino gaming system may comprise only network racks and no network bridges. Additionally, in an alternative embodiment, a casino gaming system may comprise any combination of one or more network bridges and one or more network racks.

The back-end system 112 may be configured to comprise one or more servers. The type of server employed is generally determined by the platform and software requirements of the gaming system. In one embodiment, as illustrated in FIG. 7, the back-end 112 is configured to include three servers: a slot floor controller 114, a casino management server 116 and a casino database 118. The slot floor controller 114 is a part of the player tracking system for gathering accounting, security and player specific information. The casino management server 116 and casino database 118 work together to store and process information specific to both employees and players. Player specific information includes, but is not limited to, passwords, biometric identification, player card identification, and biographic data. Additionally, employee specification information may include biographic data, biometric information, job level and rank, passwords, authorization codes and security clearance levels.

Overall, the back end 112 performs several fundamental functions. For example, the back end 112 can collect data from the slot floor as communicated to it from other network components and maintain the collected data in its database. The back end 112 may use slot floor data to generate a report used in casino operation functions. Examples of such reports include, but are not limited to, accounting reports, security reports, and usage reports. The back-end 112 may also pass data to another server for other functions. Alternatively, the back-end 112 may pass data stored on its database to floor hardware for interaction with a game or game player. For example, data such as a game player's name or the amount of a ticket being redeemed at a game may be passed to the floor hardware. Additionally, the back end 112 may comprise one or more data repositories for storing data. Examples of types of data stored in the system server data repositories include, but are not limited to, information relating to individual player play data, individual game accounting data, gaming machine accounting data, cashable ticket data, and sound data including optimum audio outputs for various casino settings.

Of course, one will appreciate that a gaming system 100 may also comprise other types of components, and the above illustrations are meant only as examples and not as limitations to the types of components or games used in a casino gaming system having a multi-hand blackjack element.

In addition to gaming machines and gaming systems, various methods for managing gaming machines having movable top boxes are disclosed herein. According to one method, a player initiates a gaming session. Typically, the player inserts credit onto the gaming machine, places a wager, and initiates game play. Once game play is initiated, one or more game outcomes are presented on the main display 17. According to one method, the top box of the gaming machine will move in response to a triggering event. The movement of the top box includes the movement of the top box in a vertical direction, flipping the top box 180.degree., rotating the top box about a vertical axis, tilting the top box away from or toward a player, or oscillating the motion of the display. In another method, the movement of the top box in a vertical direction reveals a secondary display that is positioned behind or within the top box. In one method, the secondary display may also move in the x,y,z directions in response to one or more triggering events.

The triggering event is a condition that needs to be satisfied in order to move the top box or the secondary display. According to one embodiment, the triggering event is a computer or system generated response such as, but not limited to, a message from a system host, a message from another networked gaming machine, or a winning outcome in a primary game. For example, the triggering event may be a symbol combination of “cherry-cherry-cherry” for a slots-type game. In a poker game, the triggering event may be a pair of jacks or better. In other embodiments, the triggering event may be any winning outcome having a low or high probability. In those embodiments where a gaming machine presents both a primary game and a secondary game, the triggering event may be an outcome in either the primary or the secondary game. The primary game and/or the secondary game may be a video game or a mechanical game (e.g., a game having one or more reels or wheels). As those skilled in the art will appreciate, the triggering event may be any possible game outcome and does not necessarily have to be a winning outcome.

Additionally, triggering events may be based upon player activity/actions. For example, the triggering event may be based upon player performance such as, but not limited to, inserting a player tracking card into the gaming machine, time of play, frequency of play (i.e., number of games played in a particular period of time), number of maximum bets, number of player points earned, or a combination thereof. Additionally, a triggering event may be the player possessing a radiofrequency identification (RFID) tag while playing a gaming machine or walking by one or more gaming machines to trigger an attract mode of a game. In these embodiments, a random performance characteristic may be selected to initiate the single-player-initiated, grouped bonus period. For example, the bonus period may be triggered when a player has played the game for 30 minutes. Alternatively, achieving a predetermined performance threshold for a particular performance characteristic may be required to initiate the limited-time bonus period. For example, a bonus period may be initiated when a player has made twelve maximum bets. In another embodiment, the triggering event may be based upon the number of credits on the gaming machine. That is, a random or predetermined number of credits will trigger the bonus period. As those skilled in the art will appreciate, one or more of any of the disclosed triggering events may be required to initiate the movement of the top box.

### Overview of Discount Percentage Awards (DPA):

If the sum of all DPA's earned from a randomly selected tier option (e.g., 3,4,5-tier etc.) and each random DPA disbursement from within each of its tier levels (e.g., A, B, C etc.). DPA's range between 0.02% up to 100% DPA shoe or deal is finite requiring a replacement shoe or reshuffle upon completion DPA's are qualified by set total and accumulative total spend or wager limit parameters (e.g., $100 fixed or $100-$120 range). The accumulative DPA total provides a reduction on gross payment due (e.g., $100 less DPA of 20%=pay $80). If the gross payment is pre-paid then the 20% DPA=$20 cashback award DPA's are an operational expense.

Provider has DPA algorithm configuration control to set limits on spend and percentages (e.g., $20 spend has chance of winning a top DPA of 30%) DPA qualifier guaranteed a reduction on gross payment or cashback award DPA's are awarded at point-of-sale terminals (e.g., slot machine, cashier, checkout, etc.)

Cashback redemption may be instant or saved as [symbol] ASH$ [symbol] ALE$; a free game of chance offered to a qualified customer at a point-of-sale terminal wherein a guaranteed win of an unknown random discount percentage award from 2% to 100% reduces or eliminates the gross cost of a product or service.

The method may have a player inputting at least one wager at the player input terminal, wherein inputting at the player input panel comprises at least one input entered by at least one control selected from the group consisting of buttons, touchscreens, levers, voice recognition and eye movement recognition components. The method may have a player initiates a direction of movement over the near field communication system directs activity, including the ticket-in-ticket-out technology (scanning and printing), currency validation, and wallet transmission/communication.

There may be an external antenna coupled to the device via any suitable cable connector, such as BNC, F-type, FME, MC-Card, MCX, MMCX, QMA, SMB, SSMB, and the like.

NFC is a set of short-range wireless technologies, typically requiring a separation of 10 cm or less. NFC operates at 13.56 MHz on ISO/IEC 18000-3 air interface and at rates ranging from 106 kbit/s to 424 kbit/s. NFC always involves an initiator and a target; the initiator actively generates an RF field that can power a passive target. This enables NFC targets to take very simple form factors such as unpowered tags, stickers, key fobs, or cards. NFC peer-to-peer communication is possible, provided both devices are powered.

NFC tags contain data and are typically read-only but may be writeable. They can be custom encoded by their manufacturers or use NFC Forum specifications. The tags can securely store personal data such as debit and credit card information, loyalty program data, PINS and networking contacts, among other information. The NFC Forum defines four types of tags that provide different communication speeds and capabilities in terms of configurability, memory, security, data retention and write endurance. Tags currently offer between 96 and 4,096 bytes of memory.

As with proximity card technology, near-field communication uses magnetic induction between two loop antennas located within each other's near field, effectively forming an air-core transformer. It operates within the globally available and unlicensed radio frequency ISM band of 13.56 MHz. Most of the RF energy is concentrated in the allowed ±7 kHz bandwidth range, but the spectral mask for the main lobe is as wide as 1.8 MHz. Theoretical working distance with compact standard antennas: up to 2.0 cm (practical working distance of about 10 cm). Supported data rates: 106, 212 or 424 kbit/s (the bit rate 848 kbit/s is not compliant with the standard ISO/IEC 18092)

The two modes are: Passive—The initiator device provides a carrier field and the target device answers by modulating the existing field. In this mode, the target device may draw its operating power from the initiator-provided electromagnetic field, thus making the target device a transponder.
Active—Both initiator and target device communicate by alternately generating their own fields. A device deactivates its RE field while it is waiting for data. In this mode, both devices typically have power supplies.

| | Active | Passive |
|---|---|---|
| Speed | Device | Device |
| 424 kbit/s | Man. 10% ASK | Man. 10% ASK |
| 212 kbit/s | Man. 10% ASK | Man. 10% ASK |
| 106 kbit/s | Mod. Miller 100% ASK | Man. 10% ASK |

NFC employs two different coding to transfer data. If an active device transfers data at 106 kbit/s, a modified Miller coding with 100% modulation is used. In all other cases Manchester coding is used with a modulation ratio of 10%.
NFC devices are full-duplex they are able to receive and transmit data at the same time. Thus, they can check for potential collisions if the received signal frequency does not match the transmitted signal's frequency.
Although the range of NFC is limited to a few centimeters, plain NFC does not ensure secure communications. NFC offers no protection against eavesdropping and can be vulnerable to data modifications. Applications may use higher-layer cryptographic protocols (e.g. SSL) to establish a secure channel.
The RF signal for the wireless data transfer can be picked up with antennas. The distance from which an attacker is able to eavesdrop the RE signal depends on multiple parameters but is typically less than 10 meters. Also, eavesdropping is highly affected by the communication mode. A passive device that doesn't generate its own RF field is much harder to eavesdrop on than an active device. An attacker can typically eavesdrop within 10 m and 1 m for active devices and passive devices, respectively.
Because NFC devices usually include ISO/IEC 14443 protocols, relay attacks are feasible. For this attack the adversary forwards the request of the reader to the victim and relays its answer to the reader in real time, pretending to be the owner of the victim's smart card. This is similar to a man-in-the-middle attack. ¹One libnfc code example demonstrates a relay attack using two stock commercial NFC devices. This attack can be implemented using only two NFC-enabled mobile phones.

### NFC Protocol Stack Overview

NFC standards cover communications protocols and data exchange formats and are based on existing RFID standards including ISO/IEC 14443 and FeliCa. The standards include ISO/IEC 18092 and those defined by the NFC Forum.
NFC is standardized in ECMA-340 and ISO/IEC 18092. These standards specify the modulation schemes, coding, transfer speeds and frame format of the RF interface of NFC devices, as well as initialization schemes and conditions required for data collision-control during initialization for both passive and active NFC modes. They also define the transport protocol, including protocol activation and data-exchange methods. The air interface for NFC is standardized in:
ISO/IEC 18092/ECMA-340 Near Field Communication Interface and Protocol-1 (NFCIP-1)
ISO/IEC 21481/ECMA-352 Near Field Communication Interface and Protocol-2 (NFCIP-2)
   NFC incorporates a variety of existing standards including ISO/IEC 14443 Type A and Type B, and FeliCa. NFC-enabled phones work at a basic level with existing readers. In “card emulation mode” an NFC device should transmit, at a minimum, a unique ID number to a reader. In addition, NFC Forum defined a common data format called NFC Data Exchange Format (NDEF) that can store and transport items ranging from any MIME-typed object, ultra-short RTD-documents,^{[44]} such as URLs. The NFC Forum added the Simple NDEF Exchange Protocol (SNEP) to the spec that allows sending and receiving messages between two NFC devices.

In the practice of the present invention, NFC may be used for local downloading of the underlying app of the present technology onto a PDA (e.g., smart phone, pad, etc.) and to communicate between the kiosk, slot machine or central server and the PDA. The NFC communication can be used to execute any action desired between the plyer and the system, including changing accounts, altering percentages (where possible), confirming identity and player accounts, and the like.

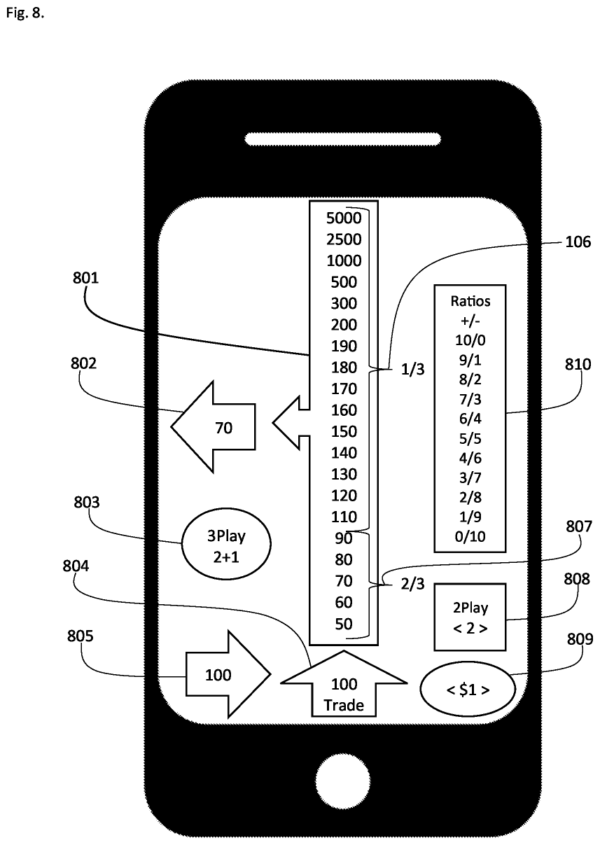

FIG. 8 shows a mobile device with 801 exchange credit paytable, 802 an exchange credit meter displaying discount or cashback credits for redemption only, 803 is the ‘2+1’ player-initiated incentive that guarantees a minimum return on 3 consecutive trade and exchange events guaranteed minimum return of e.g., 70% by delivering two negative wins plus one positive win to the exchange credit meter and, 804 a fixed trade credit amount (e.g., 100) that functions as a player-initiated start button, 805 is the trade credit meter displaying tradable credits only, 806 showing the ⅓^{rd} hit frequency bracket of positive wins on the exchange paytable and 807 showing the ⅔^{rd} hit frequency bracket of negative wins on the exchange paytable, 808 is a multi-trade and exchange selector in 2-trade increments (e.g., 2, 4, 6, 8, 10) of consecutive trade and exchange events, 809 is the denomination selector. 810 is a player-initiated option where a predetermined random hit frequency streak ratio between positive and negative wins is selected for 10 consecutive trade and exchange events.

FIG. 9 shows the number of randomly distributed redeemable predetermined exchange credits within FIFO queues per ‘Set’ (All) for ‘single and double play’ trade and exchange events and the separated negative win versus positive win exchange awards that reflect the 2-1 negative-positive win ratio delivery method for the ‘triple play’ option and another negative win versus positive win exchange awards the ‘streaks’ ratios delivery method to cater to the 4 trade options.

FIG. 10 shows the central controller for pooling non-redeemable trade credits for the distribution of redeemable exchange credits from and to a community of linked electronic devices.

FIG. 11 shows the addition of a ‘Trade & Exchange’ button, ikon or entry function to the game machine or player interface. For purposes of an example, only, it is shown in FIG. 11 next to the ‘Spin’ button. The function may be described as “Players may opt for a trade and exchange over a spin and alternate between the two wherein the autonomous trading credits are deducted from their credit meter into a pool from where exchange credits are credited back to their credit meter in a player community competition for credits from any slot machine”.

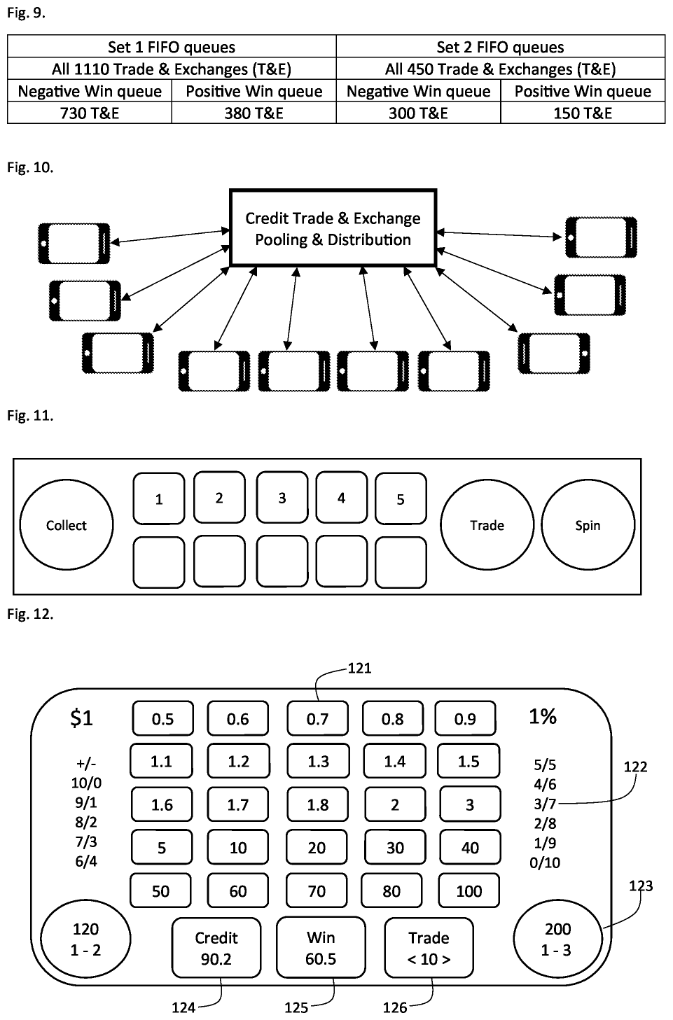

FIG. 12 shows a screen layout with cost of trade and service fee, exchange rates 121 ranging from a minimum low of 0.5 for 1 (50% of trade) out to a maximum of e.g., 200 for 1 from 27 random options. Positive win/negative win ratios 122 determine how many of each award category the player receives e.g., 3 positive wins plus 7 negative wins to make a win total while hit frequency options 123 determine how many positive versus negative wins in play e.g., 33.33% vs 66.67% (1-2) or 25% vs 75% (1-3) and highest award. Player credits 124 are redeemable, win credits 125 are credited and selected trade credits 126 are randomly exchanged to build a win total.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method of providing a variable, fixed, finite probability, discount percentage award game comprising:
a. providing a game processor and a display screen in communications with the game processor;
b. the game processor recognizing a wager of value in an underlying game of chance executed by the game processor;
c. before during or after executing the underlying game of chance, the game processor identifies a specific value or percentage to be used in the computation of discount percentage awards and cashback awards;
d. the game processor displaying the value or percentage to be used in the computation of discount percentage awards and cashback awards;
e. the game processor or live game table executing the underlying game to a result conclusion;
f. information regarding the result conclusion of the underlying game is accessed by the game processor; and
g. based on the result conclusion and identified specific value or percentage identified for use in computation of discount percentage awards and cashback awards, the game processor displays respective discount percentage awards and cashback awards on the display screen and credits corresponding credits to respective accounts for discount percentage awards and cashback awards.

2. The method of claim 1 wherein the underlying game is executed on a slot machine with a random number generator identifying random outcomes in the execution of the underlying game.

3. The method of claim 1 wherein the underlying game is executed on a live gaming table, and the video display is used to identify specific payments as a result conclusion providing and underlying game concluding that requires an award to at least one player.

4. The method of claim 1 wherein the display screen displays a virtual image of a balance system, with two supplementary percentages that add up to 100%, with one display limited to a range of 2.02% to 100% display of a percentage.

5. The method of claim 4 wherein the one display is randomly selected by the game processor, and the virtual image is displayed before start of a game event, during play of the game event and/or upon conclusion of the game event.

6. The method of claim 1 wherein the display screen is in a top box.

7. The method of claim 6 wherein the top box contains a physically moving element with two distinct opposed viewing areas, one viewing area for display of the discount percentage award and another viewing area for display of the cashback awards.

8. The method of claim 7 wherein the two distinct opposed viewing areas comprise two individual viewing screens separated from each other.

9. The method of claim 8 wherein the two individual viewing screens are supported on a bar which tilts to show differences between the discount percentage award and the cashback award.

10. The method of claim 1 wherein outcomes in an underlying game are determined by a first random number generator and amounts of the discount percentage award and the cashback award.

11. The method of claim 1 wherein a player at the game processor or live table game connects a personal data apparatus to a server in communication with the game processor, and when a predetermined value of outcome results has been achieved, the server in communication with the game processor alerts the personal data apparatus of achievement of that redetermined value of outcome.

12. A gaming apparatus comprising a housing, player input controls, gaming processor, display screen for exhibiting information on an underlying wagering game and an area of view on the housing dedicated to display of amounts of a discount percentage award and a cashback award,
wherein the game processor is programmed to select or enable selection of a range of discount percentage awards and to display that selected discount percentage award and the cash back award simultaneously.

13. The gaming apparatus of claim 12 wherein the display screen is in a top box.

14. The gaming apparatus of claim 13 wherein the top box contains a physically moving element with two distinct opposed viewing areas, one viewing area for display of the discount percentage award and another viewing area for display of the cashback awards.

15. The gaming apparatus of claim 14 wherein the two distinct opposed viewing areas comprise two individual viewing screens separated from each other.

16. The gaming apparatus of claim 15 wherein the two individual viewing screens are supported on a bar which tilts to show differences between the discount percentage award and the cashback award.

17. The gaming apparatus of claim 16 wherein outcomes in an underlying game are determined by a first random number generator and amounts of the discount percentage award and the cashback award.

18. The gaming apparatus of claim 12 wherein input through a button, recognized voice entry, or icon initiates a signal to the gaming process to enable a player to elect at least one event selected from the group consisting of a trade of credits between different players at a same or different gaming apparatus and an exchange of credits for an award available for a defined number of credits over a spin and alternate between the two wherein the autonomous trading credits are deducted from their credit meter into a pool from where exchange credits are credited back to their credit meter in a player community competition for credits from any slot machine.

19. An electronic gaming machine configured to execute a wagering event, the electronic gaming machine comprising a housing, a video display, a processor, memory, player input controls at least one player position and a value-in-value-out credit creation component for entering credit into memory which can be used to place wagers through the player input controls selected from the group consisting of a) a ticket-in-ticket-out system having a ticket-reading scanner and ticket printer, b) a currency validation system having a motor drive to advance currency past a scanner, and c) a near field communication system comprising a sensor in the gaming system and a readable card, tag or key that can communicatively interact with the sensor in the electronic gaming machine, the memory containing executable software that enables implementation of the wagering event with steps comprising:
a) providing a game processor and a display screen in communications with the game processor;
b) the game processor recognizing a wager of value in an underlying game of chance executed by the game processor;
c) before during or after executing the underlying game of chance, the game processor identifies a specific value or percentage to be used in the computation of discount percentage awards and cashback awards;
d) the game processor displaying the value or percentage to be used in the computation of discount percentage awards and cashback awards;
e) the game processor or live game table executing the underlying game to a result conclusion;
f) information regarding the result conclusion of the underlying game is accessed by the game processor; and
g) based on the result conclusion and identified specific value or percentage identified for use in computation of discount percentage awards and cashback awards, the game processor displays respective discount percentage awards and cashback awards on the display screen and credits corresponding credits to respective accounts for discount percentage awards and cashback awards.

20. The electronic gaming machine of claim 19 wherein input through a button, recognized voice entry, or icon initiates a signal to the gaming process to enable a player to elect at least one event selected from the group consisting of a trade of credits between different players at a same or different gaming apparatus and an exchange of credits for an award available for a defined number of credits over a spin and alternate between the two wherein the autonomous trading credits are deducted from their credit meter into a pool from where exchange credits are credited back to their credit meter in a player community competition for credits from any slot machine.
